(19) United States
(12) Patent Application Publication
(10) Pub. No.: US 2024/0393179 A1
(43) Pub. Date: Nov. 28, 2024

(54) SYSTEM AND METHOD FOR SPECTROSCOPIC DETERMINATION OF INTENSITY LEVEL AND SIGNAL-TO-NOISE RATIO FROM SAMPLE SCANS

(71) Applicant: THERMO SCIENTIFIC PORTABLE ANALYTICAL INSTRUMENTS INC., Tewksbury, MA (US)

(72) Inventors: Rafet MALTAS, Tewksbury, MA (US); Lin ZHANG, Andover, MA (US)

(21) Appl. No.: 18/674,335

(22) Filed: May 24, 2024

Related U.S. Application Data
(60) Provisional application No. 63/504,670, filed on May 26, 2023.

(51) Int. Cl. G01J 3/44; G01J 3/02; G01J 3/28

(52) U.S. Cl. CPC G01J 3/44; G01J 3/027; G01J 2003/2833; G01J 2003/2836

(57) ABSTRACT

Methods and systems for predicting signal quality. One analytical instrument support system receives preliminary sample data collected from a short scan of a sample. The analytical instrument support system determines a bright-max intensity level based on preliminary sample data. The analytical instrument support system determines a performance class based on, at least, the bright-max intensity level. The analytical instrument support system determines an intensity-to-time model, the intensity-to-time model includes a plurality of intensity to levels and a plurality of exposure times based on, at least, one or more deviations from an intensity linear model, the one or more deviations associated with the determined performance class. The analytical instrument support apparatus determines a first maximum intensity level based on, at least, a first corresponding exposure time and the intensity-to-time model, or a first parameter exposure time based on, at least, a first corresponding intensity level and the intensity-to-time model.

### RELATED APPLICATIONS

This application claims priority to U.S. Provisional Patent Application No. 63/504,670, filed May 26, 2023, the entire content of which is incorporated by reference herein.

### FIELD

The present disclosure generally relates to systems and methods for conducting spectroscopic analytical techniques, such as Raman spectroscopy. In particular, systems and methods are disclosed for determining a sample's spectrum intensity level and signal-to-noise ratio from a short scan of a physical sample.

### BACKGROUND

Raman spectroscopy is an effective tool for identifying and characterizing various sample compounds and substances. In Raman spectroscopy, light typically from a laser and of a known wavelength (typically infrared or near infrared) is directed at a sample compound or substance. The laser light (also sometimes referred to as a Raman pump) interacts with the electron clouds in the molecules of the sample compound or substance and, as a result of this interaction, experiences selected wavelength shifting. The precise nature of this wavelength shifting depends upon the materials present in the sample compound or substance. A unique wavelength signature (typically called the Raman signature) is produced by each sample compound or substance. This unique Raman signature permits the sample compound or substance to be identified and characterized. More specifically, the spectrum of light returning from the sample compound or substance is analyzed with a spectrometer so as to identify the Raman-induced wavelength shifting in the Raman pump light, and then this wavelength signature is compared (e.g., by a computing device) with a library of known Raman signatures, whereby to identify the precise nature of the sample compound or substance.

Raman spectroscopy is widely used in scientific, commercial and public safety areas. Current state-of-the-art methods and systems assume that exposure times and intensity levels are linearly dependent, and that intensity levels and signal-to-noise ratio (SNR) values are quadratically dependent. Moreover, current state-of-the-art systems and methods utilize the assumptions to determine the time requirements to determine the specific compound or substance from the sample compound or substance. However, these assumptions cause unpredictability and lack of reliance in the current state-of-the-art systems and methods.

For example, in ideal cases, the level of bright signal produced by Raman systems should increase linearly with the exposure time within the dynamic range, wherein the dynamic range represents the range between the base signal at (theoretically) 0 milliseconds exposure time and the saturation point, where further increases in expose time no longer increase the signal level. However, the linearity of the signal depends on various factors, such as, for example, the detectors used in the systems, the chemical samples, and the exposure time. Due to these factors, the linearity may not always hold within the dynamic range, which makes it difficult to accurately predict the quality of signals in different exposure times.

### SUMMARY

Accordingly, examples described herein accurately predict signal quality for an exposure time, which offers a valuable value proposition by accurately predicting the signal quality for any quality of chemical measured under a short exposure time. This prediction enables increased efficiency of the systems, resulting in more accurate results in less time and the utilization of untapped potential of the systems. For example, examples described herein employ a short scan to predict the signal intensity for a desired expired time, wherein this predicted signal intensity can be used to further predict the signal quality (e.g., measured by a signal-to-noise ratio (SNR)). Also, vice versa, examples described herein can be used to predict an exposure time to achieve a desired signal quality based on a short scan.

In one aspect, a computer-implemented method is disclosed. One or more processors receive preliminary sample data collected from a short scan of a sample. One or more processors determine a bright-max intensity level based on preliminary sample data. One or more processors determine a performance class based on, at least, the bright-max intensity level. One or more processors determine an intensity-to-time model, the intensity-to-time model including a plurality of intensity levels and a plurality of exposure times based on, at least, one or more deviations from an intensity linear model, the one or more deviations associated with the determined performance class. One or more processors determine a first maximum intensity level based on, at least, a first corresponding exposure time and the intensity-to-time model, or a first parameter exposure time based on, at least, a first corresponding intensity level and the intensity-to-time model. The first maximum intensity level or the first parameter exposure time are stored on one or more computer-readable memory devices.

In another aspect, an analytical instrument support system is disclosed. The analytical instrument support system includes one or more computer processors, one or more non-transitory computer-readable storage media, and program instructions stored on at least one of the one or more non-transitory computer readable storage media for execution by at least one of the one or more processors. The program instructions include program instructions to (i) receive preliminary sample data collected from a short scan of a sample; (ii) determine a bright-max intensity level based on, at least, the preliminary sample data; (iii) determine a performance class based on, at least, the bright-max intensity level; (iv) determine an intensity-to-time model, the intensity-to-time model including a plurality of intensity levels and a plurality of exposure times based on, at least, one or more deviations from an intensity linear model, the one or more deviations associated with the determined performance class; (v) determine a first maximum intensity level based on, at least, a first corresponding exposure time and the intensity-to-time model, or a first parameter exposure time based on, at least, a first corresponding intensity level and the intensity-to-time model; and (vi) store, on one or more computer-readable memory devices, the first maximum intensity level or the first parameter exposure time.

In another aspect, an analytical instrument is disclosed. The analytical instrument includes a light source configured to direct light onto a surface of a sample and a spectrograph to acquire a Raman spectrum from the surface of the sample in response to the light source directing light onto the surface of the sample. The analytical instrument further includes one or more computer processors, one or more non-transitory computer-readable storage media. Upon execution of the program instructions by at least one of the one or more processors, the analytical instrument is caused to implement the following acts, including (i) analyzing Raman spectrum data from the acquired Raman spectrum associated with the surface of the sample, (ii) determining a bright-max intensity level based on, at least, the acquired Raman spectrum, (iii) determining a performance class based on the bright-max intensity level associated with the acquired Raman spectrum, (iv) determining an intensity-to-time model, the intensity-to-time model including a plurality of intensity levels and a plurality of exposure times based on, at least, one or more deviations from an intensity linear model, the one or more deviations associated with the determined performance class; (v) determining a first maximum intensity level based on, at least, a first corresponding exposure time and the intensity-to-time model, or, a first parameter exposure time based on, at least, a first corresponding intensity level and the intensity-to-time model, and (vi) storing on at least one of the one or more non-transitory computer-readable storage media the first maximum intensity level or the first parameter exposure time.

There is no specific requirement that a system, method, or technique relating to determination-based spectroscopy include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

Features and advantages of the present technology will become more apparent from the following detailed description of exemplary embodiments thereof taken in conjunction with the accompanying drawings in which:

FIG. 1 is a block diagram of an exemplary analysis system, according to some implementations of the present disclosure.

FIG. 2 illustrates an optical architecture for a spectrometer included in the analysis system of FIG. 1, according to some implementations of the present disclosure.

FIG. 3 illustrates another optical architecture for the spectrometer included in the analysis system of FIG. 1, according to some implementations of the present disclosure.

FIG. 4 illustrates a further optical architecture for the spectrometer included in the analysis system of FIG. 1, according to some implementations of the present disclosure.

FIG. 5 illustrates yet another optical architecture for the spectrometer included in the analysis system of FIG. 1, according to some implementations of the present disclosure.

FIG. 6A is a flowchart of an exemplary process to determine a first maximum intensity level or a first parameter exposure time, according to some implementations of the present disclosure.

FIG. 6B illustrates an exemplary process to determine a deviation from a linear line.

FIG. 7A is a flowchart of an exemplary process to determine a first SNR value or a second maximum intensity level, according to some implementations of the present disclosure.

FIG. 7B illustrates an exemplary process to determine a deviation from a linear line.

FIG. 8 is a flowchart of an exemplary process to determine a second SNR value or a second parameter exposure time, according to some implementations of the present disclosure.

FIG. 9 illustrates an exemplary table of performance classes associated with a range of bright-max intensity values, according to some implementations of the present disclosure.

FIG. 10A illustrates an exemplary intensity to time model for an exemplary sample compound, according to some implementations of the present disclosure.

FIG. 10B illustrates an SNR to intensity model for exemplary sample compound of FIG. 10A.

FIG. 11A illustrates another exemplary intensity to time model for another exemplary sample compound, according to some implementations of the present disclosure.

FIG. 11B illustrates another SNR to intensity model for the exemplary sample compound of FIG. 11A.

FIG. 12A illustrates another exemplary intensity to time model for another exemplary sample compound, according to some implementations of the present disclosure.

FIG. 12B illustrates another SNR to intensity model for the exemplary sample compound of FIG. 12A, according to some implementations of the present disclosure.

FIG. 13A illustrates another exemplary intensity to time model for another exemplary sample compound, according to some implementations of the present disclosure.

FIG. 13B illustrates another SNR to intensity model for the exemplary sample compound of FIG. 13A.

FIG. 14A illustrates another exemplary intensity to time model for another exemplary sample compound, according to some implementations of the present disclosure.

FIG. 14B illustrates another SNR to intensity model for the exemplary sample compound of FIG. 14A.

FIG. 15A illustrates a block diagram of an exemplary method for the operation of an exemplary Raman spectrometer, according to some implementations of the present disclosure.

FIG. 15B illustrates a block diagram of another exemplary method for the operation of an exemplary Raman spectrometer, according to some implementations of the present disclosure.

While the present technology is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Systems, methods and techniques disclosed herein may provide improved modeling that make determinations of intensity level, exposure time, and signal-to-noise-ratio (SNR) for spectroscopy results more accurate. For example, the present disclosure provides increased accuracy in Raman spectroscopy results, in comparison to linearly dependent exposure time and intensity level models, through improved methods for determining accurate intensity level and signal-to-noise ratio (SNR) values from a short scan of the sample to obtain a preliminary sample data. Similarly, the present disclosure provides increased accuracy in Raman spectroscopy results, in comparison to quadratically dependent intensity levels and signal-to-noise ratio models, through improved methods of determining, by modifying previous assumptions that the intensity level linearly increases as exposure time increases and that SNR increases quadratically as intensity level increases. The improvements of the present disclosure are desirable because of the increased confidence in determining measurement parameters for obtaining a spectrum after the short scan of the sample for obtaining preliminary sample data. The increased confidence in determining parameters is further beneficial because of the improved reliability of the determination of a compound or substance by a spectrometer based on a scan of a sample of the compound or substance.

As described herein, the Raman measurement parameters for the analytic system are initial targets provided as instructions to the analytic instrument for obtaining a spectrum. The Raman measurement parameters can include scan time, intensity of a peak (such as the most intense peak), or the SNR. The system and methods described herein model these Raman measurement parameters so that if one parameter is chosen, the other parameters can be determined as outputs. For example, if the Raman measurement parameter provided as the preliminary instruction is to scan for a particular scan time, then peak intensities and SNR of the collected spectrum are determined for a targeted scan time. In some implementations, if the Raman measurement parameter provided is a preliminary instruction to scan a target SNR, then the scan time can be determined for achieving the targeted SNR and the peak intensities. In some implementations, if the Raman measurement parameter provided is a preliminary instruction to scan to achieve a target peak intensity, then scan time to achieve the target peak intensity and the SNR of the resultant spectrum can be determined.

As described above, current state-of-the art systems and methods assume exposure times and intensity levels are linearly dependent, and the intensity levels and the SNR are quadratically dependent. The current state-of-the-art systems and methods utilize those assumptions to predict the total time requirements to determine an accurate scan of a sample after the preliminary short scan. However, current state-of-the-art systems and methods do not produce accurate results based on exposure times and intensity levels that are assumed to be linearly dependent. Moreover, the assumptions used in current state-of-the-art systems result in inaccurate determinations of samples. The present disclosure overcomes the deficiencies of the current state-of-the-art by providing improved, accurate predictions for the total scan time that are both reliable and are provided in a faster manner than current state-of-the-art systems and methods. The present disclosure further overcomes the deficiencies of earlier systems by determining compounds or substances from a scan of the sample by using predictions of intensity levels and SNR values that deviate from the linear and/or quadratic models, respectively.

In some implementations, the present disclosure provides for predicting accurate scan times that includes predicting accurate intensity levels and SNR values from the preliminary short scan. Rather than approximating that the intensity level linearly increases as exposure time increases and that SNR increases quadratically as intensity level increases, some implementations of the present disclosure deviate from a linear model of a sample compound or substance exponentially, logarithmically, or both. The exponential and logarithmic deviations from the linear model provide for more accurate predictions of the determination of the compound or substance from the scan of the sample.

In some implementations, systems and method of the present disclosure include determining (i) an intensity level based on an exposure time; (ii) an exposure time based on an intensity level; (iii) an SNR value based on an intensity level; (iv) an intensity level based on an SNR value; (v) an SNR value based on an exposure time; and/or (vi) an exposure time based on a signal-to-noise (SNR) value. Such determinations are based on determining an intensity-to-time model and a SNR-to-intensity model for the compound or substance. Where the intensity of a signal increases with the exposure time or scan time, and the SNR increases with the intensity of the signal, the two models can desirably be used to make the above predictions from a preliminary short scan.

While some examples described herein calculate intensity level as the maximum of the highest peak of the signal, in some implementations, the intensity level may be calculated for each pixel separately. By adopting this approach, such implementations can predict the entire signal across different exposure times.

Unless otherwise defined, all technical and scientific terms used herein have the same meaning as commonly understood by one of ordinary skill in the art. In case of conflict, the present document, including definitions, will control. Example methods and systems are described below, although methods and systems similar or equivalent to those described herein can be used in practice or testing of the present disclosure. All publications, patent applications, patents and other references mentioned herein are incorporated by reference in their entirety. The systems, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“Raman measurement” refers to a Raman system where the illumination spot diameter remains fixed-size and has a uniform radial distribution.

“Aspheric diffuse ring producing optic” refers to various implementations for producing the distributed spot which includes an aspheric diffuse ring producing optic, or ADRPO. In some implementations, aspheric optics may include what is referred to as an axicon or conical optic which produces a ring of intensity but has higher order aspheric terms to produce the spread-out pattern. In some implementations, the aspheric optic may have coefficients of A1=0.01, A2=0.06, and A4=0.002, with all other terms being zero.

“Collimating lens” refers to optical elements that transform the incoming light direction to parallel paths.

“Filter” refers to optical elements that remove some wavelengths of incoming light.

“Focusing optics” refers to optical elements that transform the incoming light direction to a point in space.

“Light source” refers to a light source used for excitation in spectroscopy application. Exemplary systems and methods may include a laser that is adapted for Raman spectroscopy such as 785 m, or 1064 nm. Exemplary light sources could also include a broad band source such as an LED.

“Sample surface plane” refers to the surface of the sample under test where the illumination area is directed.

“Steering mirrors” refers to optical elements used to change the direction of light path.

“Raman spectrum” refers to a spectrum of data values that may include a bright spectrum and/or a dark spectrum. Where the bright spectrum is the scattered light from the sample hitting a detector. The dark spectrum is a spectrum received when no light hits the detector. The dark spectrum captures the shape of the baseline offset.

In some implementations, a short scan comprises a duration of exposure time for each of bright Raman spectra and dark Raman spectra between 1 millisecond (ms) to 10 seconds. In some implementations, a short scan comprises a duration of time between 1 millisecond (ms) to 10 seconds; 1 ms to 9 seconds; 1 ms to 8 seconds; 1 ms to 7 seconds; 1 ms to 6 seconds; 1 ms to 5 seconds; 5 ms to 5 seconds; 25 ms to 5 seconds; 50 ms to 5 seconds; 100 ms to 5 seconds; 100 ms to 4.5 seconds; 100 ms to 4 seconds; 100 ms to 3.5 seconds; 100 ms to 3 seconds; 100 ms to 2.5 seconds; 100 ms to 2 seconds; 100 ms to 1.5 seconds; 100 ms to 1 seconds; 100 ms to 900 ms; 100 ms to 800 ms; 100 ms to 700 ms; 100 ms to 600 ms; 100 ms to 500 ms; 100 ms to 400 ms; 100 ms to 300 ms; 100 ms to 200 ms; or about 100 ms. In some implementations, a short scan comprises a duration of time of no less than 100 ms; no less than 200 ms; no less than 300 ms; no less than 400 ms; no less than 500 ms; no less than 600 ms; no less than 700 ms; no less than 800 ms; no less than 900 ms; no less than 1 second; no less than 2 seconds; no less than 3 seconds; or no less than 4 seconds. In some implementations, a short scan comprises a duration of time of no greater than 5 seconds; no greater than 4.5 seconds; no greater than 3.5 seconds; no greater than 2.5 seconds; no greater than 1.5 seconds; no greater than 950 ms; no greater than 850 ms; no greater than 750 ms; no greater than 650 ms; no greater than 550 ms; no greater than 450 ms; no greater than 350 ms; no greater than 250 ms; no greater than 150 ms, or about 100 ms.

The present disclosure is now described with reference to the drawings, wherein like reference numerals are used to refer to like elements throughout. In the following description, for purposes of explanation, numbers of specific details are set forth in order to provide an improved understanding of the present disclosure. It may be evident, however, that the systems and methods of the present disclosure may be practiced without one or more of these specific details. In other instances, well-known structures and devices are shown in block diagram form in order to facilitate describing the systems and methods of the present disclosure.

It should be understood that although implementations are described herein as being used with a spectrometer or other optical instrument, implementations can be constructed as stand-alone devices for measuring an electrochemical property of a sample compound or substance. Furthermore, although some implementations are described herein with respect to measuring an electrochemical property of a sample compound or substance, exemplary methods and systems described herein can be used to measure other electrochemical properties, such as, for example a Raman spectrum of the sample compound or substance.

Exemplary analysis systems, such as Raman spectroscopy systems, can be used in a variety of environments to identify unknown materials, to evaluate the threat posed by unknown materials, to provide positive identification of packaged raw materials, or to provide general security screening functions of a variety of substances. Exemplary analysis systems can include a wide range of sizes, from portable, handheld instruments to larger systems in permanent laboratories.

### I. Exemplary Analysis Systems

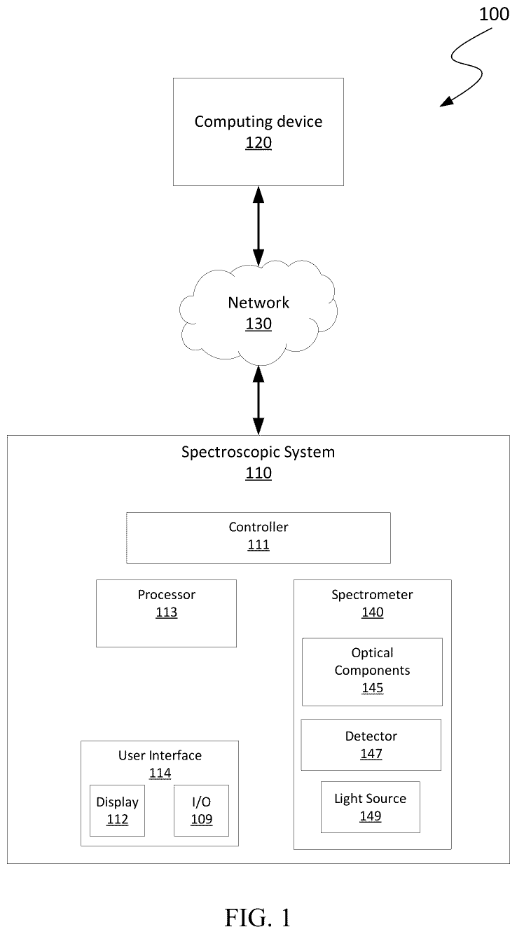

Those of ordinary skill in the art appreciate that there are a variety of different optical architectures and arrangements utilized in the field of Raman spectroscopy. FIG. 1 provides an illustrative example of an analysis system 100 (also referred to herein as “analyzer 100”) that comprises an optical architecture and other elements that operate to measure one or more Raman spectra from a sample via one or more of the methods described herein.

The analyzer 100 illustrated in FIG. 1 includes a spectroscopic system 110 communicatively coupled to a computing device 120 via a network 130. As illustrated in FIG. 1, the spectroscopic system 110 includes a controller 111, an electronic signal processor 113, and a spectrometer 140 (e.g., a Raman spectrometer).

It will be appreciated that, in some implementations, at least a portion of the computing device 120 may be located separate from the spectroscopic system 110, which provides the opportunity for increased computing power at a central location or across multiple locations. One skilled in the art can envision various interconnections, both physical and wireless, between the components of the analyzer 100. It will further be appreciated that, in some implementations, the spectroscopic system 110 and the computing device 120 may be communicatively coupled without the network 130 (e.g., via a dedicated wired or wireless connection). Alternatively, some implementations of the analyzer 100 may not require the resources of computing device 120 but may instead utilize resources internal to the spectroscopic system 110 to perform the methods described herein. Thus, computing device 120 may not be necessary for operation of the analyzer 100 and/or the spectroscopic system 110 and the example of FIG. 1 should not be considered as limiting. As described herein, the analyzer 100 may be used to measure one or more Raman spectra from a sample compound or substances via one or more of the methods described herein.

It should be understood that, in some implementations, the components of the analyzer 100 and/or the spectroscopic system 110 illustrated in FIG. 1 may be included in a common housing forming an analytical instrument that may include a benchtop or a portable Raman spectrometer device (e.g., a handheld device). However, in other implementations, one or more components of the analyzer 100 and/or the spectroscopic system 110 may be contained in separate housings or devices and may be coupled (e.g., communicatively, electrically, mechanically, or the like) as needed to carry out the methods described herein. Also, in some implementations, the operations described herein as being performed by the components of the analyzer 100 and/or the spectroscopic system 110 may be combined and distributed in various ways. For example, in some implementations, an electronic signal processor 113 may be part of a controller 111, wherein the controller 111 is configured to perform the operations of the electrical signal processor 113 as described herein. Furthermore, the operations described herein as being performed by the controller 111 may be distributed among multiple controllers. In the same or alternative examples, operations described herein as being performed by controller 111 may be distributed among one or more computing devices (e.g., the electronic signal processor 113, the computing device 120, or multiple computing devices). In some implementations, the controller 111 is configured to control operation of the spectrometer 140, wherein the electronic signal processor 113 is configured to control other components of the spectroscopic system 110 (e.g., communication with the computing device 120). However, these roles of the controller 111 and the electronic signal processor 113 may be combined and distributed in various ways, and, in some implementations, the spectroscopic system 110 includes only the controller 111 or the electronic signal processor 113 and the included devices performed the functionality of both the controller 111 and the electronic signal processor 113 as described herein.

The spectroscopic system 110 may also include additional components (such as power components), a user interface 114 (such as a display 112 and/or user input and/or output (“I/O”) interface 109, such as, for example, a keyboard, a mouse, a touch screen), optical components (e.g., mirrors, lens, fiber optic cables, gratings, and filters), and the like. The spectrometer 140 included in the spectroscopic system 110 includes one or more optical components 145, a detector 147 (e.g., a CCD detector, a PMT detector, or other detector known in the art), and a light source 149. The light source 149 provides an excitation beam (e.g., excitation laser providing 785 nm or 1064 nm light) to a sample (not shown in FIG. 1).

As described above, the spectroscopic system 110 and/or the spectrometer 140 may comprises a fully integrated portable system operated by a user on battery power to take Raman spectroscopy measurements in a variety of environments, such as, for example, a laboratory setting, a manufacturing (e.g., bioreactor based) setting, a remote setting, etc. Also, in the same or alternative implementations, elements of the spectroscopic system 110 may be utilized as separated systems communicatively connected (e.g., optically, wirelessly, electrically, mechanical, and the like) operated on battery power and/or power outlets connected to a central power source to take Raman spectroscopy measurements in the variety of environments described.

Referring now to light source 149 of spectrometer 140, it will be appreciated that implementations of light source 149 may emit wavelengths of light as needed for an application, for example, including or between a range of about 400 nm to about 1064 nm, a range of about 400 nm to about 750 nm, a range of about 400 nm to about 600 nm, a range of about 400 nm to about 500 nm, a range of about 600 nm to about 900 nm, a range of about 700 nm to about 850 nm, a range of 600 nm to 1064 nm, a range of 750 nm to 1064 nm, a range of 850 nm to 1064 nm, a range of 950 nm to 1064 nm, as well as a wavelength of about 785 nm, or a wavelength of about 1064 nm.

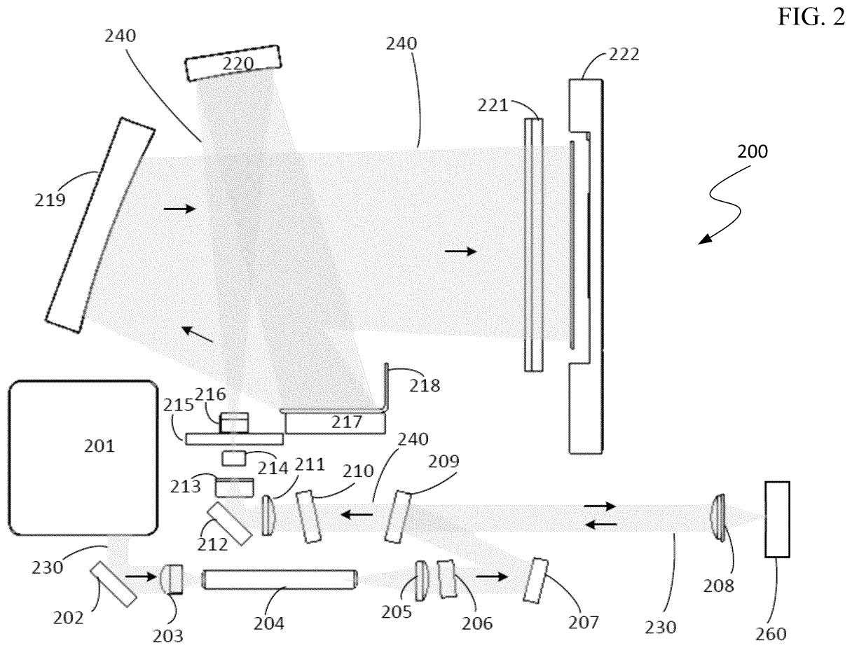

FIG. 2 provides an illustrative example of one implementation of an optical architecture comprising optical components of the spectrometer 140 (see FIG. 1), that are otherwise collectively referred to herein as an optical system 200. It will be appreciated that different optical architectures of Raman spectrometer are known in the art and thus the example of FIG. 2 should not be considered as limiting. For example, some implementations employ what are referred to as transmission gratings rather the reflection gratings, as well as associated differences in optical architecture.

The example of FIG. 2 illustrates one implementation of light source 149 (see FIG. 1) as laser assembly 201 comprising a laser source that produces a beam of light that travels along optical or beam path 230 (e.g., arrows illustrate direction of travel of the light beam) to sample 260. It will be appreciated that sample 260 may include any type of sample of interest to a user and may include substantially dry samples (e.g., a powder, solid material), substantially fluid samples (e.g., a liquid, gas), or some combination thereof (e.g., a gel). In response to the light from laser assembly 201, the sample 260 produces scattered light (e.g., comprising a Raman portion and a Rayleigh portion of scattered light), which travels along optional or beam path 240.

In some implementations, the laser assembly 201 may produce laser power as needed for an application for example, including or between a range of about 250 mW to about 750 mW; about 250 mW to about 700 mW; about 250 mW to about 650 mW; about 250 mW to about 600 mW; about 250 mW to about 550 mW; about 250 mW to about 500 mW; about 250 mW to about 450 mW; about 250 mW to about 400 mW; about 250 mW to about 350 mW; about 250 mW to about 300 mW; or about 250 mW. Also in some implementations, the laser power affects the values of the base value and the bright-max intensity values when sample 260 is scanned. It will be appreciated that other ranges and/or levels of laser power are known in the art and thus the example described for laser assembly 201 should not be considered as limiting.

FIG. 2 also illustrates one implementation of an architecture that directionally controls the beam path 230 and the beam path 240 as well as conditions one or more characteristics of the beam of light produced from the laser assembly 201 as well as from the sample 260. For example, a turning mirror 202 redirects beam path 230 to focusing lens 203 that focuses the beam onto a waveguide phase scrambler 204 (e.g., to adjust the phase characteristics of the beam). The beam exits waveguide phase scrambler 204 and travels to a collimating lens 205 (e.g., which adjusts collimation characteristics of the beam), then to a broadband filter 206 transmissive to a specific wavelength or range of wavelengths of light. The beam travels to a flat mirror 207 that redirects the beam path 230 to a selective element 209. It will be appreciated that the selective element 209 may include a dichroic mirror, a notch filter, or other element that comprises substantially reflective characteristics to the wavelength(s) of the beam from laser assembly 201 and comprises substantially transmissive characteristics to a wavelength or wavelength range associated with Raman scattered light from sample 260. In the described example, selective element 209 redirects the beam path 230 to a lens 208 that focuses the beam to the sample 260. In the described example, the lens 208 may include any type of lens known in the art such as an objective lens that focuses the beam onto the sample 260. Also, some implementations of the lens 208 comprise special configurations and characteristics that provide advantages for different types of the sample 260 as will be described below.

The lens 208 collects Raman scattered light and Rayleigh scattered light produced from the sample 260 in response to the beam from the laser assembly 201 and produces the beam path 240 that travels back to the selective element 209 and a second selective element 210. As described above, the selective elements 209 and 210 are substantially transmissive to the wavelengths of the Raman scattered light, allowing the beam path 240 to pass through to additional optical elements that further adjust the path and conditions the characteristics of the beam traveling along the beam path 240. For example, the optical elements may include a focusing lens 211, a flat mirror 212, a baffle 213, a slit 214, a baffle 215, and a collimating lens 216.

The beam path 240 travels from the collimating lens 216 to a mirror 220 that reflects the beam path 240 toward a diffraction grating 217. It will be appreciated that, in the example of FIG. 2, the diffraction grating 217 comprises a reflective diffraction grating that produces a spectral distribution of light. The beam path 240 then travels to a focusing mirror 219 that redirects the beam path 240 to a focusing lens 221 that directs the beam to elements of a detector 222 (one implementation of the detector 147 of FIG. 1). It will also be appreciated that FIG. 2 illustrates a baffle 218 that, in some implementations, controls stray light.

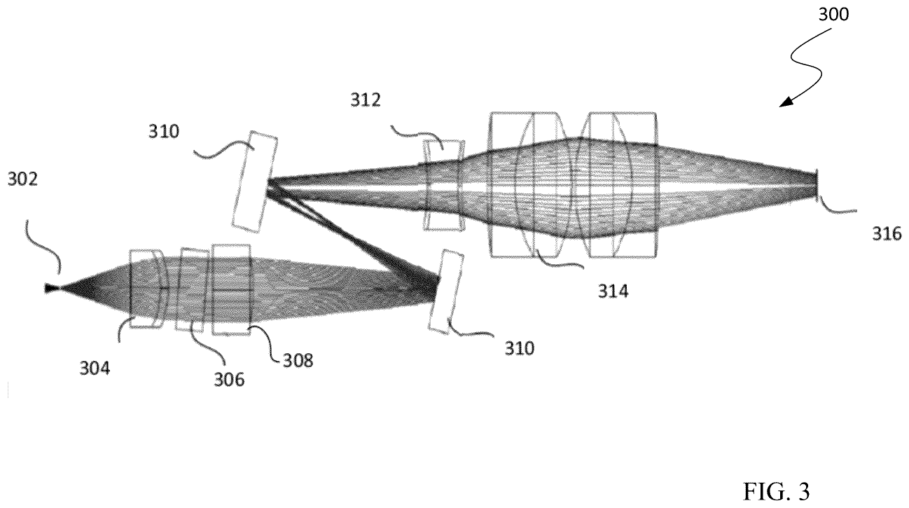

As described above, it will be appreciated that a variety of implementations of lens 208 are available that provide different focusing and light collection characteristics. For example, FIG. 3 provides an example implementation of an optical architecture useful for analyzing a sample contained in a package (e.g., a bag, bottle, etc.), where the optical architecture comprises some components of the optical system 200 (see FIG. 2) and other components that provide the characteristics of lens 208 (see FIG. 2), collectively referred to as an optical arrangement 300. In the described example, the optical arrangement 300 includes an element 302 that may include a focusing lens 203 (see FIG. 2) or an output from an optical fiber. Element 302 directs a beam (e.g., produced from light source 149 or laser assembly 201 or a Raman laser 119—see FIGS. 1, 2, and 5) to a collimating lens 304 that produces a substantially collimated beam. In the described example, the collimating lens 304 can be movably mounted such that it can change position along the axis of the optical path. The range of motion includes a range of about 0.1 mm to about 10 mm to allow for a change in spot size on the sample surface to range from about 10 microns to about 10 mm. It will also be appreciated that in some implementations any of the collimating lens 304, a concave focusing lens 312, and/or focusing optics 314, either alone or in combination, may be movably mounted to effect a change in spot size.

The collimating lens 304 directs the substantially collimated beam into an aspheric diffuse ring producing optic 308 configured to produce a light pattern that is radially diffuse. The intensity of the output from the aspheric diffuse ring producing optic 308 is more intense at the outer edge of the resulting pattern than in the center. While this pattern could be projected directly onto a sample surface 316, in practical application it is advantageous to use one or more steering mirrors 310, one or more filters 306, and focusing elements, such as, for example, a concave focusing lens 312 and focusing optics 314, to direct the radially diffuse light pattern onto the sample surface 316.

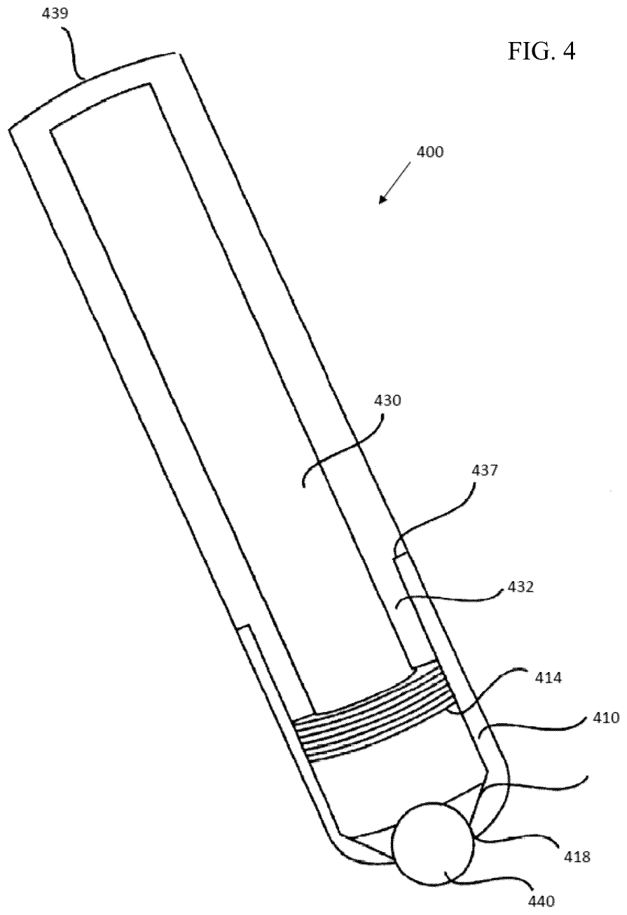

FIG. 4 provides an example of another implementation of the lens 208 (see FIG. 2), wherein this example may be useful for analyzing a fluid or semi-fluid sample. The implementation illustrated in FIG. 4 comprises some components of the optical system 200 and other components that provide characteristics of what is generally referred to as an “immersion probe,” wherein the components are collectively referred herein to as an optical arrangement 400. The implementation illustrated in FIG. 4 comprises a spherical lens 440 seated within a cylindrical probe tip 410 at lens opening 418. A seal between the probe tip 410 and the lens 440 is formed at the opening by any means known in the art, including all forms of welding or braising and the use of epoxies or other adhesives. The probe tip 410 may be any length. Optionally, the probe tip 410 may have threads 414 on its interior surface and may be extended using probe tube 430, which has threaded collar 432 for threading into probe tip 410. A seal is optionally formed between probe tube lip 437 and the distal end of probe tip 410. Further, in the described example, the optical arrangement 400 includes fiber optic coupling 439 that transmits illumination light from the laser assembly 201 (see FIG. 2) as well as scattered light from the sample 260 (see FIG. 2), wherein the sample 260 may include a liquid sample where lens 440 is immersed in the liquid. Also in the described example, the optical arrangement 400 may be configured as a separated element from spectroscopic system 110 (see FIG. 1) where an optical fiber provides optical communication between spectroscopic system 110 and the optical arrangement 400.

It will be appreciated that the examples provided in FIG. 3 and FIG. 4 are for the purposes of illustration and some implementations may include additional or fewer elements as needed for an application. For instance, in some implementations one or more windows, collimating lenses or other optical elements may be employed in applications that utilize a fiber optic coupling or other need for conditioning a beam or protecting internal environments. Therefore, the examples provided in FIG. 3 and FIG. 4 should not be considered as limiting.

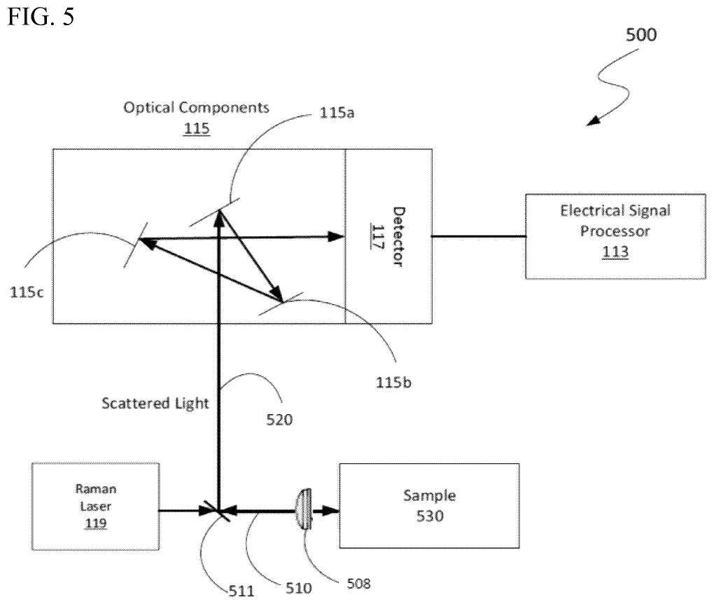

FIG. 5 provides another example of an implementation of an optical architecture comprising optical components of the spectrometer 140 (see FIG. 1), that are otherwise collectively referred to herein as the optical system 500. It will be appreciated that different optical architectures of Raman spectrometer are known in the art and thus the example of FIG. 5, similar to the examples of FIGS. 1 to 4, should not be considered as limiting.

The example of FIG. 5 illustrates one implementation of the light source 149 (see FIG. 1) as a Raman laser 119 comprising a laser source that produces a beam of light that travels along a first optical or beam path 510 (e.g., arrows illustrate direction of travel of the light beam) to a sample 530. Like sample 260 (see FIG. 2), it will be appreciated that sample 530 may include any type of sample of interest to a user which may include substantially dry samples (e.g., a powder, solid material), substantially fluid samples (e.g., a liquid, gas), or some combination thereof (e.g., a gel). In response to the light from the Raman laser 119, the sample 530 produces scattered light along a second optical or beam path 520 (e.g., comprising a Raman portion and a Rayleigh portion of scattered light).

In some implementations, the Raman laser 119 may produce laser power as needed for an application for example, including or between a range of about 250 mW to about 1050 mW, including various subranges therebetween such as the non-limiting subranges described above for the light source 149 and the laser assembly 201. It will also be appreciated that in some implementations, the laser power affects the values of the base value and the bright-max intensity values when the sample 530 is scanned.

FIG. 5 illustrates an architecture that in some implementations directionally controls the first beam path 510 and/or the second beam path 520. In some implementations, the beam paths 510, 520 can be controlled using one or more of turning mirrors, waveguide phase scramblers, various lenses, broadband filters, or selective elements (e.g., mirrors, notch filters, or other elements with substantially reflective characteristics to the wavelength(s) of the beam from the Raman laser 119 and/or substantially transmissive characteristics to a wavelength or wavelength range associated with Raman scattered light from sample 530). In the described example, a selective element 511 is transmissive to the laser wavelengths emitted from the Raman laser 119 allowing the first beam path 510 to be directed to a lens 508 that focuses the beam onto the sample 530. In the described example, the lens 508 may include any type of lens known in the art such as an objective lens or lens architecture such as used in the optional arrangements 300 or 400 (see FIG. 3 and FIG. 4) that focuses the beam onto the sample 530.

Some implementations of the lens 508 include special configurations and characteristics that provides advantages for different types of samples. For example, the lens 508 can collect Raman scattered light and Rayleigh scattered light produced from the sample 530 in response to the beam from the Raman laser 119. The scattered light collected by the lens 508 is directed back from the surface of the sample 530 and travels back along the first beam path 510 to the selective element 511 (e.g., a beam splitter, such as, for example, a dichroic mirror) that directs the scattered light along the second beam path 520. In some implementations, the selective element 511 is substantially reflective to the wavelengths of the Raman scattered light, allowing the second beam path 520 to be directed to additional optical elements that further adjust the path and condition the characteristics of the beam traveling along the second beam path 520. Other optical arrangements are also contemplated for the selective element 511 for directing the scattered light along the second beam path 520.

As illustrated in FIG. 5, the optical system 500 also includes one or more optical components 115 (also referred herein as optical components 115a-115c), which can include one or more of collimating lens and mirrors, filters, such as, for example, a notch filter, diffraction gratings, and/or mirror relays. The scattered light is directed by one or more of optical components 115a-115c onto a detector 117 (an implementation of the detector 147 of FIG. 1). Signal processing and/or digitizing of signals associated with the scattered light that is received by the detector 117 is performed by an electrical signal processor associated with optical system 500, which may be, for example, the electronic signal processor 113, the controller 111, the computing device 120, or a combination thereof. For example, in some implementations, the electrical signal processor 113 may be a suitably programmed microprocessor or application specific integrated circuit including a read-only or read-write memory of any known type which holds instructions and data for spectrometer operation as described herein.

As described above, it will be appreciated that a variety of implementations of the lens 508 are available that provide different focusing and light collection characteristics.

Returning to FIG. 1, the controller 111 may additionally include an electronic processor, an input/output (I/O) interface, and a data storage device (not shown); however, it should be understood that the controller 111 may have additional or fewer components. The controller 111 is suitable for the application and setting, and can include, for example, multiple electronic processors, multiple I/O interfaces, multiple data storage devices, or combinations thereof. In some implementations, some or all of the components included in the controller 111 may be attached to one or more mother boards and enclosed in a housing (e.g., including plastic, metal and/or other materials). In some implementations, some of these components may be fabricated onto a single system-on-a-chip, or SoC (e.g., an SoC may include one or more processing devices and one or more storage devices).

As used herein, “processors” or “electronic processor” refers to any device(s) or portion(s) of a device that process electronic data from registers and/or memory to transform that electronic data that may be stored in registers and/or memory. The electronic processor included in the controller 111 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

Data storage device(s) included in the controller 111 may include one or more local or remote memory devices such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some implementations, the data storage device(s) included in the controller 111 may include memory that shares a die with a processor. In such an embodiment, the memory may be used as a cache memory and may include embedded dynamic random-access memory (eDRAM) or spin transfer torque magnetic random-access memory (STT-MRAM), for example. In some implementations, the data storage device(s) may include non-transitory computer readable media having instructions thereon that, when executed by one or more processors (e.g., the electronic processor included in the controller 111), causes the controller 111 to store various applications and data for performing one or more of the methods described herein or portions described herein. For example, one or more the data storage devices included in the controller 111 may store a prediction program, device characteristics data, performance class data, or a combination thereof. It should be understood that each method described herein may be implemented via one application or multiple applications.

Device characteristics data may include a bias and a gain (e.g., charge-coupled device (CCD) bias and CCD gain) and sigma read of the spectroscopic system 110 stored on the data storage device(s) of the controller 111. These are specific to each analytical instrument.

In some implementations, the controller 111 determines a base level intensity based on, at least, one of the one or more analytical instrument characteristics.

In some implementations, the bias may change when the power of the light source (see, e.g., light source 149 (FIG. 1), light assembly 201 (FIG. 2), or Raman laser 119 (FIG. 5)) is changed. For example, if the power of the light source changes from 250 mW to 1064 mW, the bias will correspondingly change.

Performance class data stored in the one or more data storage device(s) of the controller 111 may include a number of performance classes and a range of bright-max intensity values associated with each individual performance class stored on data storage device(s).

In some implementations, the bright-max intensity values are determined from a Raman spectrum associated with each individual scan of a sample. In some implementations, the bright-max intensity value is the largest (e.g., the highest peaks) from the Raman spectrum associated with each individual scan of a sample.

In some implementations, the performance classes are based on, at least, range(s) of bright-max intensity values, as discussed above. In some implementations, the performance classes are based on dividing the bright-max intensity levels up to the detector (see, e.g., detector 117 (FIG. 5)) saturation into ranges which define the performance classes. For example, if a saturation signal is 1,000,000 counts, ranges are selected and assigned to performance classes to cover the bright-max signal levels up to the saturation value. It is understood that the maximum saturation is device dependent, such as the specific components used in the spectroscopic system 110, and so the ranges for bright-max can also be device dependent.

In some implementations, the performance class comprises one or more performance classes. In some implementations, the performance class comprises a plurality of performance classes. In some implementations, the performance class is selected from a range including performance class 0 to performance class 100. Where each individual performance class includes a threshold lower bright-max intensity level value and a threshold upper bright-max intensity level value.

In a first non-limiting example, the spectroscopic system 110 may include performance classes from 0 to 100. In the first non-limiting example, each performance class lock steps up a range of bright-max intensity values by 50 (e.g., performance class 0 includes a range of bright-max intensity values from 0 to 49, performance class 1 includes a range of bright-max intensity values from 50 to 99, etc.).

In a second non-limiting example, the spectroscopic system 110 may include performance classes from 0 to 5. In the second non-limiting example, each performance class lock steps up a range of bright-max intensity values by 250 (e.g., performance class 0 includes a range of bright-max intensity values from 0 to 249, performance class 1 includes a range of bright-max intensity values from 250 to 499, etc.)

In a third non-limiting example, the spectroscopic system 110 may include performance classes from 0 to 49. In the third non-limiting example, each performance class lock steps up a range of bright-max intensity values by 75 (e.g., performance class 0 includes a range of bright-max intensity values from 0 to 74, performance class 1 includes a range of bright-max intensity values from 75 to 149, etc.).

Although the above examples provide performance classes with equal spans of bright-max intensity values, in some implementations the performance classes can have different spans. For example, in a fourth non-limiting example the spectroscopic system 110 can include performance classes from 0 to 5, where the steps can be of different magnitudes rather than in step of the same magnitude as in the second example above. For example, performance class 0 includes a range of bright-max intensity values from 0 to 499, performance class 1 includes a range of bright-max intensity values from 500 to 774, performance class 2 includes a range from 775 to 1249, performance class 3 includes ranges from 1250 to 1999, performance class 4 includes ranges from 1999 to 2499, and performance class includes ranges from 2500 and above-up to the saturation of the detector.

The I/O interface of controller 111 may include one or more communication chips, connectors, and/or other hardware and software to govern communications between the controller 111 and other components. The I/O interface may include interface circuitry for coupling to the one or more components using any suitable interface (e.g., a Universal Serial Bus (USB) interface, a High-Definition Multimedia Interface (HDMI) interface, a Controller Area Network (CAN) interface, a serial Peripheral Interface (SPI) interface, an Ethernet interface, a wireless interface, or any other appropriate interface). For example, the I/O interface may include circuitry for managing wireless communications for the transfer of data to and from the controller 111. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although, in some implementations the associated devices might not. Circuitry included in the I/O interface for managing wireless communications may implement any of a number of wireless standards or protocols, including but not limited to Institute for Electrical Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some implementations, circuitry included in the I/O interface for managing wireless communications may operate in accordance with a Global System for Mobile Communication (GSM), General Packet Radio Service (GPRS), Universal Mobile Telecommunications System (UMTS), High Speed Packet Access (HSPA), Evolved HPS (E-HPSA), or LTE network. In some implementations, circuitry included in the I/O interface for managing wireless communications may operate in accordance with Enhanced data for GSM Evolution (EDGE), GSM EDGE Radio Access Network (GERAN), Universal Terrestrial Radio Access Network (UTRAN), or Evolved UTRAN (E-UTRAN). In some implementations, circuitry included in the I/O interface for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some implementations, the I/O interface may include one or more antennas (e.g., one or more antenna arrays) for receipt and/or transmission of wire communications.

In some implementations, the analyzer 100 provides a stand-alone or dedicated analytical instrument or device (or set of instruments or devices) configured to perform a short scan and analysis of a sample. However, in other implementations, the analyzer 100 may be configured to perform additional scans or analysis of one or more samples. Combining such scanning abilities or analysis in one system (e.g., one analytical instrument) creates desirable efficiencies and improved accuracy in the analysis as multiple scans can be taken from the sample without having to change the position of the sample, reconfigure the analytical instrument, or use a separate scan for additional samples combined with the target sample, all of which can introduce delays and potentials for contamination or unintended variances between scans.

### II. Exemplary Methods of Operation

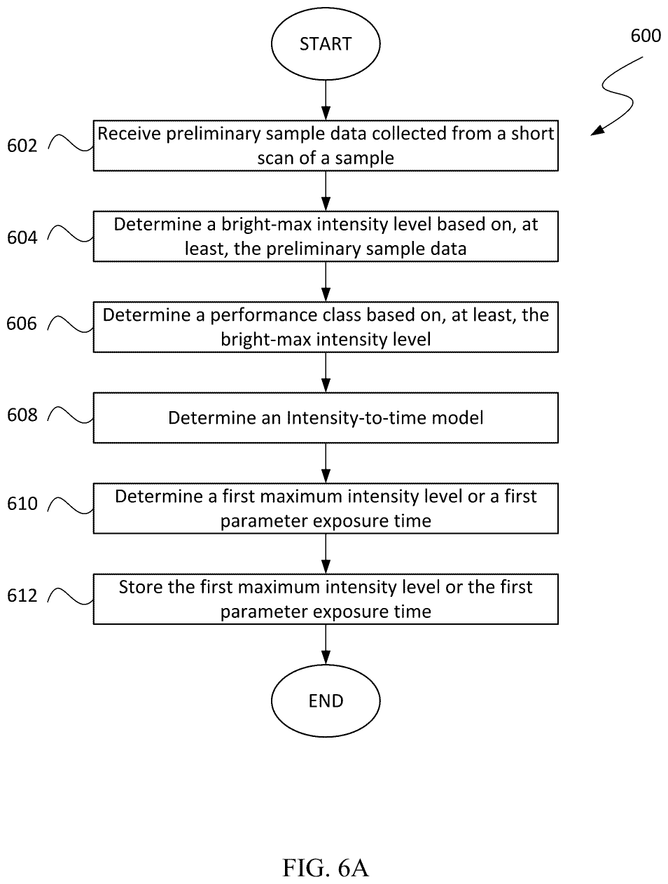

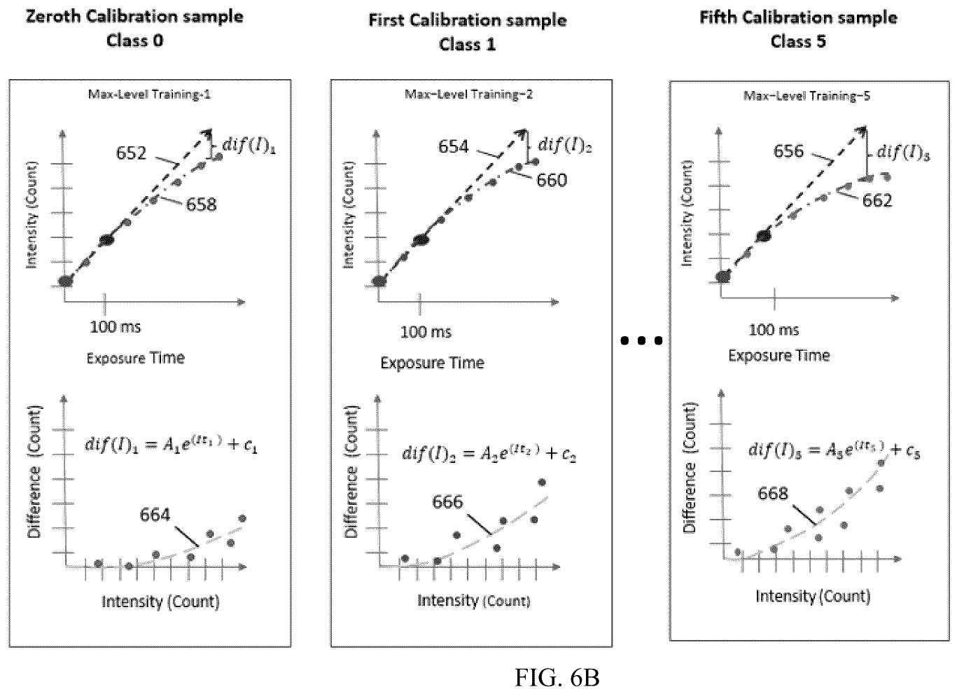

Referring now to FIG. 6A, a flowchart illustrates a process 600 for determining measurement parameters of a sample compound, in accordance with some implementations of the present disclosure. Process 600 may be implemented using the spectroscopic system 110, as described above. The process 600 is described herein as being performed via the controller 111. However, it should be understood that the process 600 may be performed by one or more software and/or hardware components in various combinations and configurations. As illustrated in FIG. 6A, the process 600 may include operations 602, 604, 606, 608, 610, or 612. In some implementations, the process 600 is performed in the order as illustrated in FIG. 6A. In some implementations, the process 600 may be performed in one or more orders other than what is illustrated in FIG. 6A.

In some implementations, process 600 may begin by performing a preliminary short scan of a sample, as discussed in detail above. The sample is scanned using, at least, the spectroscopic system 110, as described above in FIGS. 1-5. The spectroscopic system 110 directs a Raman laser beam (e.g., light), as descried above, onto a surface of a sample. The resulting scattered light is directed back through the selective element 511 and the scattered light travels along the scattered light path 520 and through the optical components 115 onto the detector 117. The resulting Raman spectrum of the sample is received by the detector 117, and signal processing and/or digitizing of the received spectrum is handled by the electrical signal processors 113.

In some implementations, a preliminary short scan of the sample is captured from 1 ms to 20 seconds exposure time. In some implementations, the preliminary short scan of the sample captures both the bright and dark Raman spectra of the sample. In some implementations, the preliminary short scan of the sample is captured at about 100 ms for each of the bright and dark Raman spectra of the sample, e.g., the total short sample scan is 200 ms. The short scan provides preliminary sample data to build models used for making all the determinations (i)-(vi) introduced earlier and described in more detail below.

In operation 602, the controller 111 receives preliminary sample data collected from a short scan of the sample.

In some implementations, the electrical signal processor 113 determines the Raman spectra data of the sample. The electrical signal processor 113 determines the bright Raman spectra data from the received Raman spectra data and communicates the bright Raman spectra data to the controller 111. In some implementations, the controller 111 generates a bright spectrum representation of the received Raman spectra data of the sample. The representation can be a visual plot (e.g., a graph) or table shown by the display 112, or the representation can be an array of values stored in a data storage device (not shown) which can be used by components of the controller such as the prediction program as described above.

In some implementations, the controller 111 may retrieve one or more device characteristics associated with the analytical instrument support apparatus from device characteristics data stored on one or more data storage device(s) included in the controller 111. The one or more device characteristics associated with the analytical instrument support apparatus may include bias, gain, and sigma read. In various implementations, the controller 111 determines the sigma read and bias based on, at least, the dark Raman spectra data.

In operation 604, the controller 111 determines a bright-max intensity level based on, at least, the received preliminary sample data. The controller analyzes brightness values associated with the preliminary sample data of the short scan of the sample and identifies the peak with the highest intensity. For example, analysis can be done by a peak searching algorithm. The controller 111 analyzes the bright Raman spectrum data and identifies the highest bright peak of the bright Raman spectrum data. In some implementations, the highest bright peak of the bright Raman spectrum data represents, at least, the bright-max intensity level of the received bright Raman spectrum data associated with the sample after the short scan. In some implementations, the controller 111 stores the bright-max intensity level on the data storage device(s) included in the controller 111. In some implementations, the bright-max intensity level is a value between 0 and a saturation of the detector 117 of the spectroscopic system 110. In some implementations, the bright-max intensity level is based on, at least, about 1 ms to about 20 seconds of exposure time of the short scan of the sample.

In operation 606, the controller 111 determines a performance class based on, at least, the bright-max intensity level.

Each individual performance class corresponds to a threshold lower bright-max intensity level value and a threshold upper bright-max intensity level value. For example, in some implementations, there are a plurality of performance classes comprising performance Class 0 to performance Class 5. Additionally, for example, in some implementations, performance Class 0 includes a bright-max intensity level from 0 to 349, performance Class 1 includes a bright-max intensity level from 350 to 499, performance Class 2 includes a bright-max intensity level from 500 to 699, performance Class 3 includes a bright-max intensity level from 700 to 1099, performance Class 4 includes a bright-max intensity level from 1100 to 1999, and performance Class 5 includes all bright-max intensity levels of 2000 or greater.

In some implementations, the controller 111 generates an intensity linear model based on, at least, (i) the base level intensity and (ii) the bright-max intensity level associated with the preliminary sample data at an exposure time, wherein the exposure time is between 1 ms and 20 seconds.

In some implementations, the controller 111 converts a domain of the generated intensity linear model from exposure time to intensity.

In operation 608, the controller 111 determines an intensity-to-time model, the intensity-to-time model including a plurality of intensity levels and a plurality of exposures times based on, at least, one or more deviations from an intensity linear model of the sample, the one or more deviations are associated with the determined performance class. For example, in some implementations, the deviation is an exponential deviation, a logarithmic deviation, or a first, second, or third order polynomial deviation. The deviations are associated with the determined performance class in operation 606, to form an intensity-to-time model associated with the determined performance class in operation 606. In some implementations, the deviations for each class are of a similar mathematical form, such as exponential but with different coefficients. In some implementations, different classes can have a deviation with a different mathematical form, for example one class having a deviation that fits an exponential curve and different class having a deviation the fits a second order polynomial form.

In some implementations, the controller 111 applies the one or more deviations to the intensity linear model. The one or more deviations are applied to the intensity linear model, where the one or more deviations subsequently form a modified model that deviates from the linear line of the intensity linear model. As will be discussed below, an example of the deviations is shown in FIG. 6B.

In some implementations, the controller 111 converts a domain of the intensity linear model from intensity to exposure time, to form the intensity-to-time model including the modified calibration sample.

In some implementations, the controller 111 determines the sample's deviation from the linear line based on a previously determined curve obtained from measured data from a calibration sample of the same class as the sample of interest. For example, the sample of interest is the sample scanned in operation 602, and a calibration sample can be a sample that responds similarly with respect to light scattering intensity and so would be in the same class.

FIG. 6B illustrates how the deviation from the linear line is determined. The performance classes are determined or assigned, such as performance classes 0, 1, 2, 3, 4, and 5 (or performance classes 0, 1, 2, . . . , and n). These are based on the bright-max values as previously described. Calibration samples are then selected for each of these performance classes. For example, a zeroth calibration sample in the class defined by bright-max values in Class 0, a first calibration sample in the class defined by the bright-max value in Class 1, a second calibration sample in the class defined by the bright-max value in Class 2, a third calibration sample in the class defined by the bright-max value in Class 3, a fourth calibration sample in the class defined by the bright-max value in Class 4, and a fifth calibration sample in the class defined by the bright-max value in Class 4. These samples are indicated above the plots shown in FIG. 6B from left to right where, for simplicity and clarity classes 2-4 are omitted. A linear model for each of the calibration samples is determined as previously described, that is by extrapolating the line for the base value and a 100 ms scan. These are shown as the straight lines 652 for the zeroth calibration sample of Class 0, the straight line 654 for the first calibration sample of Class 1, and the straight line 656 for the fifth calibration sample of Class 5. Each of the calibration samples is then scanned for increasing exposure times. A curved line passing through this data is shown illustratively as line 658 for the zeroth calibration sample, line 660 for the first calibration sample, and line 662 for the fifth calibration sample. The difference between the linear extrapolated lines 652, 654, 656, and the data of the curved lines 658, 660, 662 are calculated and a plot of difference to intensity is made for each of the calibration samples.

The plots of difference to intensity are shown in the lower plots of FIG. 6B. The difference to intensity plots is fit to a curve. These curves are shown as 664 for the zeroth calibration sample, line 666 is for the first calibration sample, and line is 668 for the fifth calibration sample. Any fitting can be made to match the trend of the data and depends on the scattering intensity response of the Raman excitation of the calibration samples. In this implementation, the best curve fit is an exponential fit which is of the form of equation (1), shown below:

$${dif ( I )}_{y} = {A}_{y} {e}^{( {It}_{y} )} + {c}_{y} \qquad ( l )$$

where dif(I)_{y} is the intensity difference,
A_{y}, C_{y} and t_{y} are coefficients for the y^{th} performance class (0-5, in this instance), and
I is the intensity.

Returning to FIG. 6A, the intensity linear model for the sample is generated based on, at least, a base value of an intensity level at 0 ms and a bright-max intensity level at 100 ms. A linear line is then constructed and extrapolated over a spectrum of intensity levels and exposures times based on, at least, a linear plot from the base value to the bright-max intensity level at 100 ms. In some implementations, the intensity linear model is an intensity to time linear line. The domain is converted from intensity level to exposure time, such that the intensity to time linear line is then depicted as exposure time to intensity level. It is understood that the controller 111 does not necessarily provide a graphical presentation of a plot or any lines, although a plot could be displayed by display 112, but rather the data representative of the plot (e.g., an array with intensity values and corresponding energy values) is manipulated by the controller 111 (e.g., an electronic processor) and stored in the one or more data storage device(s) included in the controller 111.

The controller 111 is used to determine the sample's deviation from the linear line (e.g., the exposure time to intensity level), to create the intensity-to-time model, by applying the deviations to the linear line for the class. For example, where the deviations are as described with reference to FIG. 6B, the deviation is the difference (dif(I)_{y}) as defined by the equation and coefficients of equation (1). The controller 111 subtracts the one or more intensity level predictions from the corresponding one or more intensity levels of the linear line, thereby generating a deviation model based on, at least, the subtraction of the one or more intensity level predictions from the corresponding one or more intensity levels of the linear line. For example, the sample deviates by 1300 at intensity level of 15,000 (e.g., determined intensity level of 13,700) and the sample deviates by 1735 at intensity level of 24,000 (e.g., determined intensity level of 22,265) from the intensity linear model. Where the deviation is the exponential deviation described by (dif(I)_{y}), an exponential deviation from linear model is generated.

In operation 610, the controller 111 determines a first maximum intensity level based on, at least, a first corresponding exposure time or a first parameter exposure time based on, at least, a first corresponding intensity level and the intensity-to-time model. In some implementations, the controller 111 receives an input that includes, at least, a set of program instructions to identify a first maximum intensity level based on a first corresponding exposure time. The controller 111 is used to analyze the intensity-to-time model and identifies the first maximum intensity level. In some implementations, the controller 111 receives an input that includes, at least, a set of program instructions to identify a first parameter exposure time based on a first corresponding intensity level and the intensity-to-time model. The controller 111 is used to analyze the intensity-to-time model and identifies the first parameter exposure time based on the received input of the first corresponding intensity level.

In some implementations, the controller 111 is further used to determine an intensity-to-time model. The controller 111 iterates the plurality of intensity levels until the first corresponding exposure time is reached on the intensity-to-time model, wherein an intensity level corresponding with the first corresponding exposure time is the first maximum intensity level.

In some implementations, the controller 111 is further used to determine an intensity-to-time model. The controller 111 iterates the plurality of exposure times until the first corresponding intensity level is reached on the intensity-to-time model, wherein an exposure time corresponding with the first corresponding intensity level is the first parameter exposure time.

In some implementations, the controller 111 determines the first maximum intensity level. The controller 111 receives a first sample data collected from a first sample scan of the sample, wherein the sample is scanned for the first corresponding exposure time.

In some implementations, the controller 111 determines the first parameter exposure time. The controller 111 receives a second sample data collected from a second sample scan of the sample, wherein the sample is scanned at the first corresponding intensity level.

In operation 612, the controller 111 stores the first maximum intensity level or the first parameter exposure time on the data storage device(s) included in the controller 111. In some implementations, operation 614 may additionally include the controller 111 receiving a set of program instructions to display the (i) first maximum intensity level, and (ii) the first parameters exposure time on display 112 for a user of the spectroscopic system 110.

As an example, the operator or the controller 111 can then use the determined values of the first maximum intensity level based on a first corresponding exposure time to scan the sample for the first corresponding scan time and obtain a maximum intensity level that is determined to or about the same magnitude as the first maximum intensity level. This can provide for peak intensities that are high enough for all the wavelengths of interest to provide information such as for quantitative or qualitative identification of the compound. In another example, the controller 111 can use the determined value of the first parameter exposure time based on the first corresponding maximum intensity level to scan the sample to obtain a spectrum with the first corresponding maximum intensity level in a time that is about equal to the first parameter exposure time.

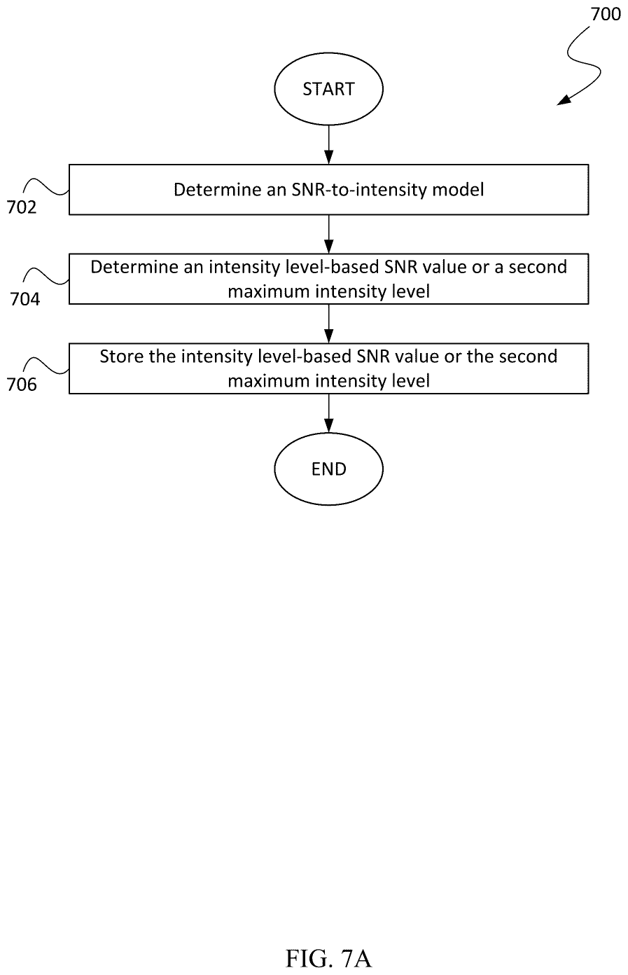

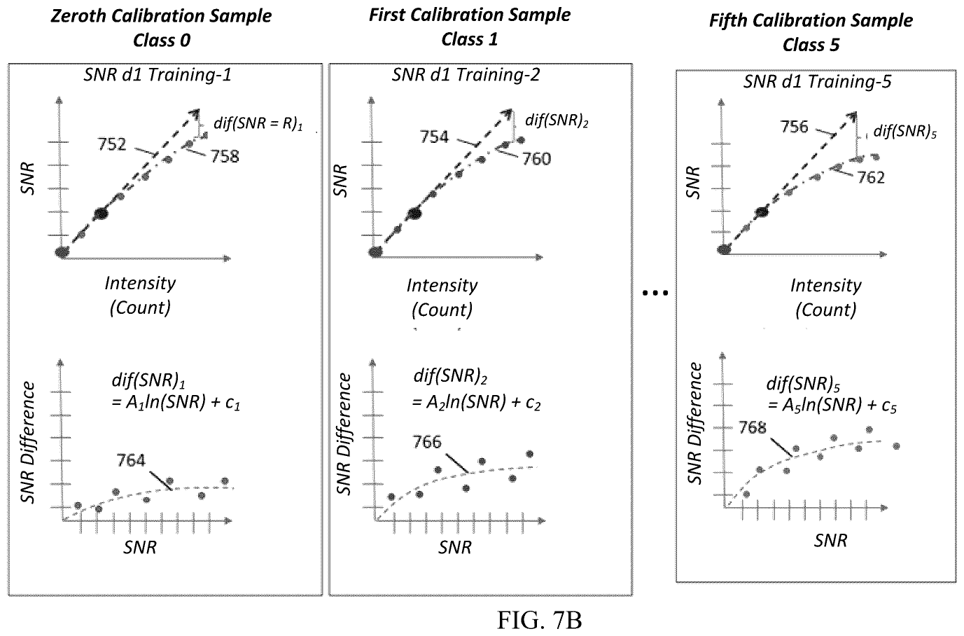

Referring now to FIG. 7A, a flowchart illustrates a process 700 for determining additional measurement parameters of the sample compound, in accordance with some implementations. Process 700 may be implemented using the spectroscopic system 110, as described above. The process 700 is described herein as being performed via the controller 111. However, it should be understood that the process 700 may be performed by multiple software and/or hardware components in various combinations and configurations. As illustrated in FIG. 7A, the process 700 may include operation 702, operation 704, or operation 706. In some implementations, the process 700 is performed in the order as illustrated in FIG. 7A. In some implementations, the process 700 may be performed in any order other than what is illustrated in FIG. 7A.

In some implementations, process 700 may begin by the controller 111 determining a threshold SNR intensity level based on the preliminary sample data collected from the short scan of the sample in operation 604, where the preliminary sample data includes a bright Raman spectra data and a dark Raman spectra data, as described above in process 600. In some implementations, the threshold SNR intensity level is calculated by subtracting the bright-max intensity level (e.g., determined from operation 604) from the respective dark Raman spectra value corresponding to the bright-max intensity level, thereby providing a difference between the bright and dark Raman spectra data.

In some implementations, the controller 111 determines the threshold SNR intensity level using an SNR estimation. In some implementations, the SNR estimation is selected from a group: (i) raw bright/dark spectra data, (ii) a first Savitsky Golay derivative transformation associated with the raw bright/dark spectra data, (iii) a second Savitsky Golay derivative transformation associated with the raw bright/dark spectra data, or (iv) SNR estimations that are known in the art.

For example, in some implementations, SNR is calculated using the following equations:

$$SNR = normderivsignalsqrt ( derivread noise + thermal noise + dark noise + shot noise ) - 1$$

$$derivX = first derivative of savitzky Gollay filter of X$$

In some implementations, process 700 may include the controller 111 generating an SNR linear model based on, at least, the threshold SNR intensity value. The base threshold SNR intensity value is associated with, at least, the preliminary sample data. The line is plotted through the origin since SNR is zero when there is no intensity (signal). It is understood that the controller 111 does not necessarily display a plot or any lines, although a plot could be displayed by display 112, but rather the data representative of the plot (e.g., an array with intensity values and corresponding energy values) is manipulated by the controller 111 (e.g., an electronic processor) and stored in the one or more data storage device(s) included in the controller 111.

In some implementations, process 700 may include the controller 111 converting a domain of the SNR linear model. The domain of the SNR linear model is converted from intensity to SNR, such that the SNR linear model is illustrated as intensity levels to SNR values. As previously described, it is understood that the controller 111 does not need to display a plot to a user of spectroscopic system 110.

In operation 702, the controller 111 determines an SNR-to-intensity model, the SNR-to-intensity model includes a plurality of SNR values and a plurality of intensities based on, at least, one or more deviations from a SNR linear model. The one or more deviations associated with the determined performance class. For the sake of brevity, the exemplary performance class(es) is described in detail above.

In some implementations, the controller 111 applies one or more deviations to the SNR linear model, thereby providing a modified calibration sample from the SNR linear model. The one or more deviations are discussed in greater detail below in FIG. 7B.

In some implementations, the controller 111 converts the domain of the SNR linear model from the SNR value to intensity level, to form the SNR-to-intensity model including the modified calibration sample.

The deviations are determined by using the calibration samples as described with reference to FIG. 7B. The second, third, and fourth calibration sample data are omitted in the figure for clarity but are treated similarly. A baseline signal to noise and the signal to noise corresponding to the 100 ms scan for each of the calibration samples is used to generate linear lines. The baseline signal to noise is zero, since at zero seconds there is no intensity (e.g., no signal). A calibration sample is provided for the zeroth calibration sample through the fifth calibration sample, illustratively shown as linear line 752 which is generated for the zeroth calibration sample which is in Class 0, linear line 754 is generated for the first calibration sample which is in Class 1, and linear line 756 is generated for the fifth calibration sample of Class 5. The signal to noise for higher intensities, such as were measured for generating the data referenced in FIG. 6B are then plotted. The bright max values increase with the time of the scan and the signal to noise increases with the time of the scan, such that the signal to noise increases with the increase in the bright max values. Curves showing the behavior of SNR to intensity are then fit to the date. Line 758 corresponds to the zeroth calibration sample, line 760 corresponds to the first calibration sample, and line 762 corresponds to the fifth calibration sample. Line 758 in FIG. 7B corresponds to the zeroth calibration sample, curved line 760 corresponds to the first calibration sample, and curved line 762 corresponds to the fifth calibration sample. The difference between the linear extrapolated lines 752, 754, 756, and the data of the curved lines 758, 760, 762 is calculated and a plot of difference to intensity is made for each of the calibration samples. These are shown in the lower plots in FIG. 7B. The difference to intensity plots is fit to a curve. These curved lines (e.g., modified calibration sample) are shown as 764 for the zeroth calibration sample, line 766 is for the first calibration sample, and line 768 is for the fifth calibration sample. Any fitting can be made to match the trend of the data and depends on the scattering intensity response of the Raman excitation of the calibration samples. In some implementations, the best curve fit is a logarithmic (natural log fit) which is of the form of equation (2), shown below:

$${dif ( SNR )}_{y} = {A}_{y} ln ( SNR ) + {c}_{y} , \qquad ( 2 )$$

where dif(SNR)_{y} is the SNR difference for the performance class y,
A_{y} and C_{y} are coefficients for line fitting, and
SNR is the signal to noise.

The controller 111 is used to determine the sample's deviation from the SNR linear line based on the deviations to the model for the class to create the SNR-to-intensity model. For example, where the deviations are as described with reference to FIG. 7B, the deviation is the difference (dif(SNR)_{y}) as defined by equation (2) with the coefficients for the class. In some implementations, the controller 111 utilizes deviation rate subtraction to determine the sample's deviation from the SNR linear line. The controller 111 subtracts (e.g., deviation rate subtraction) the determined plurality of SNR values ((dif(SNR)_{y}) from the corresponding plurality of SNR values of the linear line. For example, (i) the sample has a linear value of 100 and a deviation value of 75 (e.g., determined SNR value of 25). By way of another example, the sample has a linear value of 110 and a deviation value of 85 (e.g., determined SNR value of 35) on the SNR linear model. A logarithmic deviation from linear model is then generated based on, at least, these determined plurality of SNR values. The logarithm deviation from linear model is an implementation of the SNR-to-intensity model.

In operation 704, the controller 111 determines an intensity level-based SNR value or a second maximum intensity level. The intensity level-based SNR value is determined based on, at least, a second corresponding intensity level and the second maximum intensity level is based on, at least, a first corresponding SNR value.

In some implementations, the controller 111 receives an input that includes, at least, a set of program instructions to identify the intensity level-based SNR value based on, at least, the second corresponding intensity level. The controller 111 analyzes the SNR-to-intensity model and identifies the intensity level-based SNR value based on, at least, the received second corresponding intensity level.

In some implementations, controller 111 receives an input that includes, at least, a set of program instructions to identify the second maximum intensity level based on, at least, the first corresponding SNR value. Controller 111 analyzes the SNR-to-intensity model and identifies the second maximum intensity level based on, at least, the first corresponding SNR value. As previously described, there is a direct mapping of the scan time, the corresponding intensity, and the corresponding SNR which can be determined by the intensity-to-time model, and the SNR-to-intensity model.

In some implementations, the controller 111 determines the intensity level-based SNR value based on, at least, the second corresponding intensity level. The controller 111 receives a third sample data collected from a third sample scan of the sample, wherein the sample is scanned at the second corresponding intensity level.

In some implementations, the controller 111 determines the second maximum intensity level. The controller 111 receives a fourth sample data collected form a fourth sample scan of the sample, wherein the sample is scanned at the first corresponding SNR value.

In operation 706, the controller 111 stores the intensity level-based SNR value or the second maximum intensity level on the one or more data storage device(s) included in the controller 111. In some implementations, operation 714 may additionally include the controller 111 receiving a set of program instructions to display (i) the intensity level-based SNR value, and (ii) the second maximum intensity level.

As an example, the controller 111 can use the determined intensity level-based SNR value based on the second corresponding intensity level to scan the sample and obtain a spectrum with a SNR magnitude that is about equal to the determined intensity level-based SNR value and with the second parameter intensity level. As another example, the controller 111 can use the second maximum intensity level based on the first corresponding SNR value to scan the sample and obtain a spectrum with a max intensity level that is about equal in magnitude to the second maximum intensity level and the first corresponding SNR value. This process allows a spectrum with determined SNR values or intensities to be collected which can be used for qualitative and or quantitative identification of the sample.

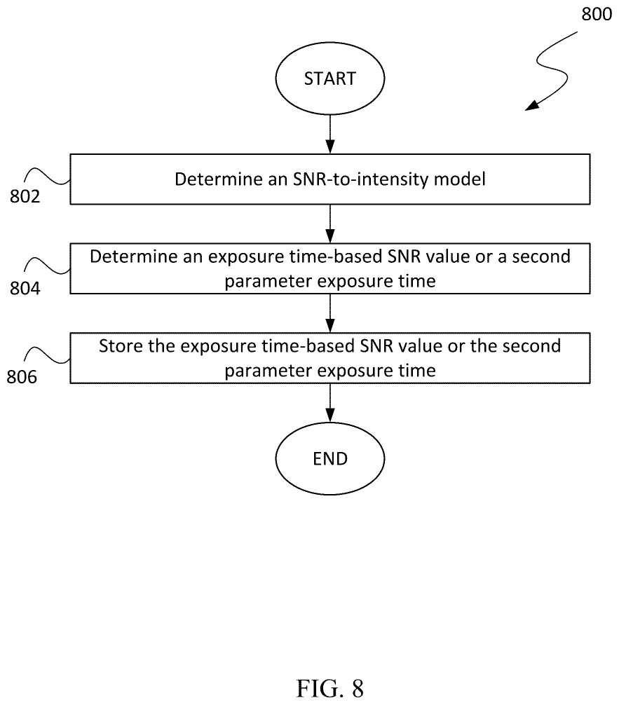

Referring now to FIG. 8, a flowchart illustrates a process 800 for determining additional measurement parameters the sample compound, in accordance with some implementations. Process 800 may be implemented using the spectroscopic system 110, as described above. The process 800 is described herein as being performed via the controller 111. However, it should be understood that process 800 may be performed by multiple software and/or hardware components in various combinations and configurations. As illustrated in FIG. 8, the process 800 may include operation 802, operation 804, or operation 806. In some implementations, the process 800 is performed in the order as illustrated in FIG. 8. In some implementations, the process 800 may be conducted in any order other than what is illustrated in FIG. 8.

Unless otherwise indicated, process 800 may include operations 602 to operation 612 and operations 802 to 806.

In some implementations, process 800 may begin at operation 802, where the controller 111 determines a threshold SNR intensity value based on a first maximum intensity level. The determined first maximum intensity level, as described in operation 610, as discussed above, may be utilized to determine the threshold SNR intensity level. In some implementations, the threshold SNR intensity level is calculated by subtracting the first maximum intensity level (e.g., determined from operation 610) from the respective dark Raman spectra data corresponding to the first maximum intensity level, thereby providing a difference between the bright Raman spectra data and the dark Raman spectra data.

In various implementations, the controller 111 determines the sigma read and bias (e.g., CCD bias) based on, at least, the dark Raman spectra data.

In some implementations, the controller 111 determines the threshold SNR intensity level by using an SNR estimation. In some implementations, the SNR estimation is selected from a group: (i) raw bright/dark spectra data, (2) a first Savitsky Golay derivative transformation associated with the raw bright/dark spectra data, (3) a second Savitsky Golay derivative transformation associated with the raw bright/dark spectra data, or (4) SNR estimations that are known in the art.

In some implementations, the controller 111 generates an SNR linear model including a calibration sample based on, at least, the threshold SNR intensity value. The threshold SNR value is associated with, at least, the preliminary sample data. The line is plotted through the origin, where SNR is be zero when there is no intensity (signal). It is understood that the controller 111 does not necessarily illustrate a plot or any lines, although a plot could be displayed by display 112, but rather the data representative of the plot (e.g., an array with intensity values and corresponding energy values) is manipulated by the controller 111 (e.g., an electronic processor) and stored in the one or more data storage device(s) included in the controller 111.

In some implementations, the controller 111 converts the domain of the SNR linear model. The domain of the SNR linear model is converted from SNR to intensity, such that the SNR linear model may be illustrated as intensity levels to SNR values. As previously described, it is understood that the controller 111 does not need to display or illustrate a plot to a user of the spectroscopic system 110.

In operation 802, the controller 111 determines an SNR-to-intensity model. The SNR-to-intensity model includes a plurality of SNR values and a plurality of intensities based on, at least, one or more logarithmic deviations from a SNR linear model. The one or more logarithmic deviations are associated with the determined performance class.

In some implementations, the controller 111 applies one or more deviations to the SNR linear model, thereby providing a modified calibration sample from the SNR linear model. The one or more deviations are discussed in greater detail above in FIG. 7B.

In some implementations, the controller 111 converts the domain of the SNR linear model from the SNR value to intensity level, to form the SNR-to-intensity model including the modified calibration sample.

In some implementations, the controller 111 determines the sample's deviation from the linear line based on, at least, the calibration samples as described with reference to FIG. 7B. In some implementations, the deviation can take the form of equation (2), shown above.

The controller 111 determines the deviation from the SNR linear line based on, at least, the plurality of SNR values and a plurality of intensities as previously described. In some implementations, the controller 111 utilizes deviation rate subtraction to determine the sample's deviation from the SNR linear line, as discussed above in process 700. Thereby generating a SNR-to-intensity model based on, at least, these determined plurality of SNR values.

In operation 804, the controller 111 determines an exposure time-based SNR value or a second parameter exposure time. The exposure time-based SNR value is determined based on, at least, a second corresponding exposure time level and the second parameter exposure time is based on, at least, the second corresponding SNR value.

In some implementations, the controller 111 receives an input that includes, at least, a set of program instructions to identify the exposure time-based SNR value based on, at least, the second corresponding exposure time. The controller 111 is used to analyze the SNR to intensity model and the intensity to time model and identifies the exposure time-based SNR value.

In some implementations, the controller 111 receives an input that includes, at least, a set of program instructions to identify the second parameter exposure time based on, at least, the second corresponding intensity level. The controller 111 is used to analyze the SNR-to-intensity model and the intensity-to-time model and identifies the first parameter exposure time.

In some implementations, the controller 111 determines the exposure time-based SNR value. The controller 111 receives a fifth sample data collected from a fifth sample scan of the sample, wherein the sample is scanned for the second corresponding exposure time.

In some implementations, the controller 111 determines the second parameter exposure time. The controller 111 receives a sixth sample data collected from a sixth sample scan of the sample, wherein the sample is scanned at the second corresponding SNR value.

In operation 806, the controller 111 stores the exposure time-based SNR value or the second parameter exposure time. In some implementations, the controller 111 receives a set of program instructions to display the exposure time-based SNR value or the second parameter exposure time on display 112 for a user. In some implementations, operation 808 may additionally include the controller 111 receiving a set of program instructions to display (i) the exposure time-based SNR value, and (ii) the second parameter exposure time.

As an example, the controller 111 can then use the determined exposure time-based SNR value based on the second corresponding exposure time to scan the sample and obtain a spectrum with a SNR magnitude that is about equal to the exposure time-based SNR value in the second corresponding exposure time. As another example, the controller 111 can use the second parameter exposure time based on the second corresponding SNR value to scan the sample and obtain a sample having the exposure time-based SNR value in a time that is about equal to the second parameter exposure time. The process allows a spectrum with determined SNR values to be collected in a known time, or the time for collecting a spectrum to achieve a target SNR value can be determined.

### III. Experimental Data

### A. Exemplary Performance Class

In some implementations, the experimental data described below in this section includes, at least, any one of the methods of operation described above in FIGS. 6-8.

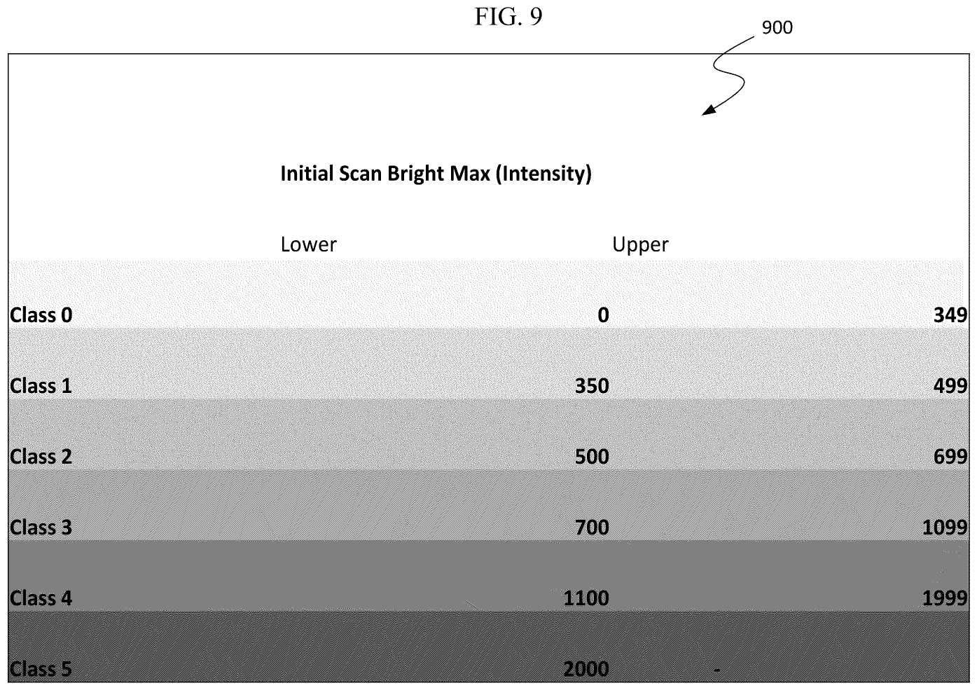

FIG. 9 includes a table 900 of an exemplary performance class hierarchy and the related lower and upper bright-max intensity value levels. For example, as illustrated, there are 6 possible performance classes, including performance Class 0, performance Class 1, performance Class 2, performance Class 3, performance Class 4, and performance Class 5. Additionally, a range of bright-max intensity values are assigned to each individual performance class. Performance Class 0 includes a bright-max intensity value from 0 to 349. Performance Class 1 includes a bright-max intensity value from 350 to 499. Performance Class 2 includes a bright-max intensity value from 500 to 699. Performance Class 3 includes a bright-max intensity value from 700 to 1099. Performance Class 4 includes a bright-max intensity value from 1100 to 1999. Performance Class 5 includes a bright-max intensity value from 2000 until the detector of the analytical instrument support apparatus has been fully saturated.

Exemplary systems and methods are not bound to what is illustrated in FIG. 9. Exemplary systems and methods may include or define any number of performance class (e.g., one or more performance classes and/or a plurality of performance classes). Additionally, exemplary systems and methods are not bound to any particular range of bright-max intensity values associated with each individual performance class. For example, there may be one performance class where the bright-max intensity value would include 0 to full saturation of the detector 117 of the analytical instrument support apparatus. In another non-limiting example, there may be two performance classes, where performance Class 0 includes bright-max intensity values from 0 to 599 and the performance Class 1 includes bright-max intensity values from 600 to full saturation of the detector of the analytical instrument support apparatus. In yet, another non-limiting example, there may be 100 performance classes, where each individual performance class increases the bright-max intensity value by 10 (e.g., performance Class 0 includes bright-max intensity values from 0 to 10, performance Class 1 includes bright-max intensity values from 11 to 20, performance Class 2 includes bright-max intensity values from 21 to 30, etc.).

### B. Exemplary Intensity-to-Time Models and Signal-to-Noise Ratio (SNR)-to-Intensity Models

In some implementations, the various sample compounds provided below in Table 1 may be utilized as a sample in one or more of the methods of operation, described above, in FIGS. 6-8.

Exemplary systems and methods tested various sample compounds and determined the bright-max intensity level based on, at least, the scanned sample data and performance class, as shown in Table 1.

TABLE 1

| | Bright-max | Performance |
|---|---|---|
| Compound Name | intensity value | Class |
| L-Histidine hydrochloride | 343 | 0 |
| monohydrate | | |
| Lactose monohydrate | 449 | 1 |
| D-Mannitol | 426 | 1 |
| Potassium phosphate | 405 | 1 |
| monobasic | | |
| L-Serine | 375 | 1 |
| Calcium stearate | 397 | 1 |
| L-Glutamine | 496 | 1 |
| Calcium carbonate | 614 | 2 |
| Acetaminophen | 689 | 2 |
| Sodium salicylate | 501 | 2 |
| Acetylsalicylic acid | 523 | 2 |
| Glycerol | 684 | 2 |
| Sodium bicarbonate | 561 | 2 |
| Diethylene glycol | 597 | 2 |
| EDTA | 602 | 2 |
| L-Ascorbic acid | 592 | 2 |
| Dimethyl Succinate | 681 | 2 |
| Cellulose (microcrystalline) | 591 | 2 |
| Titanium (IV) oxide (anatase) | 579 | 2 |
| Methanol | 888 | 3 |
| Ethylene glycol | 1016 | 3 |
| Dibutyl sebacate | 1099 | 3 |
| Mineral oil | 746 | 3 |
| Acetic acid | 1728 | 4 |
| Polydimethylsiloxane | 1763 | 4 |
| Ciprofloxacin | 1122 | 4 |
| Benzonitrile | 5300 | 5 |
| Cyclohexane | 2743 | 5 |
| Toluene | 413 | 5 |

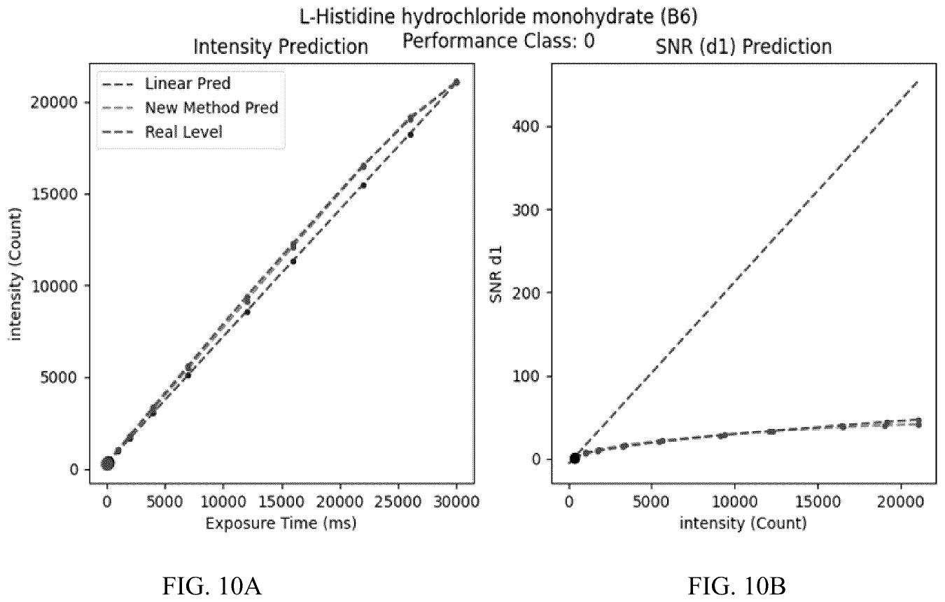

FIG. 10A illustrates an exemplary intensity-to-time model for an exemplary sample compound: L-Histidine hydrochloride monohydrate. The exemplary sample compound: L-Histidine hydrochloride monohydrate was determined to have performance Class 0. FIG. 10A further illustrates the linear line (e.g., calibration sample) for the scanned sample compound: L-Histidine hydrochloride monohydrate and illustrates the modified calibration sample (e.g., the intensity-to-time model) that includes a plurality of intensity levels and a plurality of exposure times that are based on, an exponential deviations from the linear line The coefficients for the exponential deviation are A₁=0.000473, t₁=0.000244, and c₁=−0.02757 which were derived as previously described using the calibration sample, which was chosen as calcium carbonate as the scanned compound.

FIG. 10B illustrates an exemplary SNR-to-intensity model for the exemplary sample compound: L-Histidine hydrochloride monohydrate. The exemplary sample compound: L-Histidine hydrochloride monohydrate was determined to have performance Class 0. FIG. 10B further illustrates the SNR linear line (e.g., calibration sample) for the scanned sample compound: L-Histidine hydrochloride monohydrate and illustrates the modified calibration sample (e.g., the SNR-to-intensity model) that includes a plurality of SNR values and a plurality of intensities that are based on logarithmic deviations from the SNR linear line. The coefficients for the logarithmic deviation are A₁=0.72864 and c₁=−0.1981.

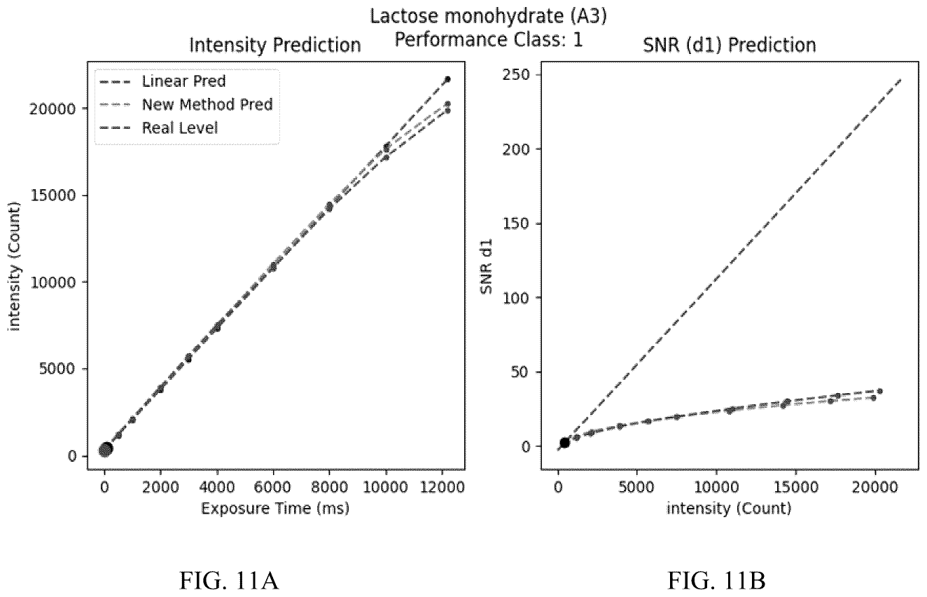

FIG. 11A illustrates an exemplary intensity-to-time model for an exemplary sample compound: lactose monohydrate. The exemplary sample compound: lactose monohydrate was determined to have performance Class 1. FIG. 11A further illustrates the linear line (e.g., calibration sample) for the scanned sample compound: lactose monohydrate and illustrates the modified calibration sample (e.g., the intensity-to-time model) that includes a plurality of intensity levels and a plurality of exposure times that are based on an exponential deviation from the linear line.

FIG. 11B illustrates an exemplary SNR to intensity model for the exemplary sample compound: lactose monohydrate. The exemplary sample compound: lactose monohydrate was determined to have performance Class 1. FIG. 11B further illustrates the SNR linear line (e.g., calibration sample) for the scanned sample: lactose monohydrate and illustrates the modified calibration sample (e.g., the SNR-to-intensity model) that includes a plurality of SNR values and a plurality of intensities that are based on a logarithmic deviation from the SNR linear line.

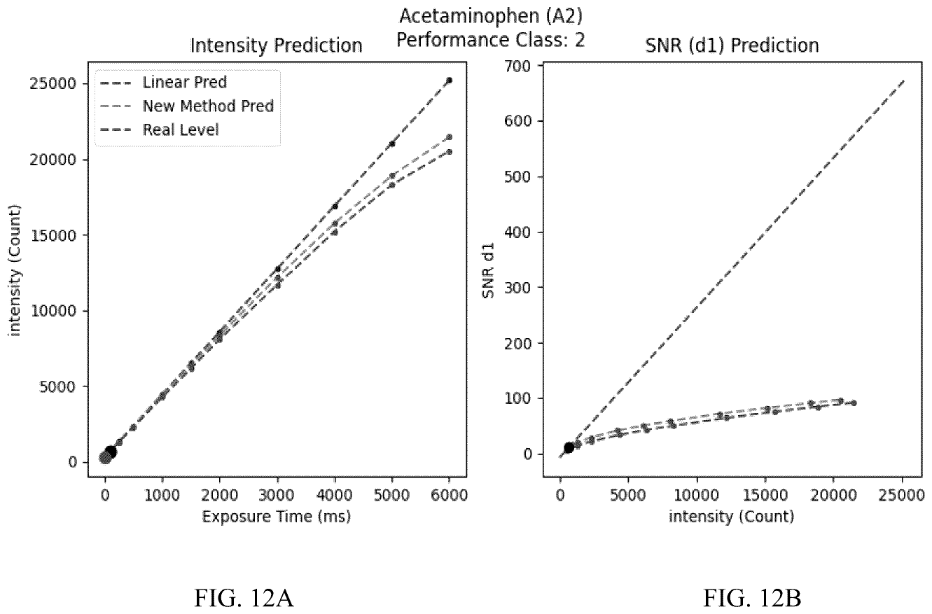

Exemplary systems and methods provide that when the determined performance class is performance Class 2 or higher (e.g., bright-max intensity level 500 or higher) the predictive model improves the accuracy in determining the measurement parameters of the scanned sample. With reference to FIGS. 12A-14B, exemplary systems and methods determined the measurement parameters of the scanned sample with improved accuracy.

FIG. 12A illustrates an exemplary intensity-to-time model for an exemplary sample compound: acetaminophen. The exemplary sample compound: acetaminophen was determined to have a performance Class 2. FIG. 12A further illustrates the linear line (e.g., calibration sample) for the scanned sample: acetaminophen and illustrates the modified calibration sample (e.g., the intensity-to-time model) that includes a plurality of intensity levels and a plurality of exposure times that are based on an exponential deviation from the linear line.

FIG. 12B illustrates an exemplary SNR to intensity model for the exemplary sample compound: acetaminophen. The exemplary sample compound: acetaminophen was determined to have performance Class 2. FIG. 12B further illustrates the SNR linear line (e.g., calibration sample) for the scanned sample: acetaminophen and illustrates the modified calibration sample (e.g., the SNR-to-intensity model) that includes a plurality of SNR values and a plurality of intensities that are based on logarithmic deviation from the SNR linear line.

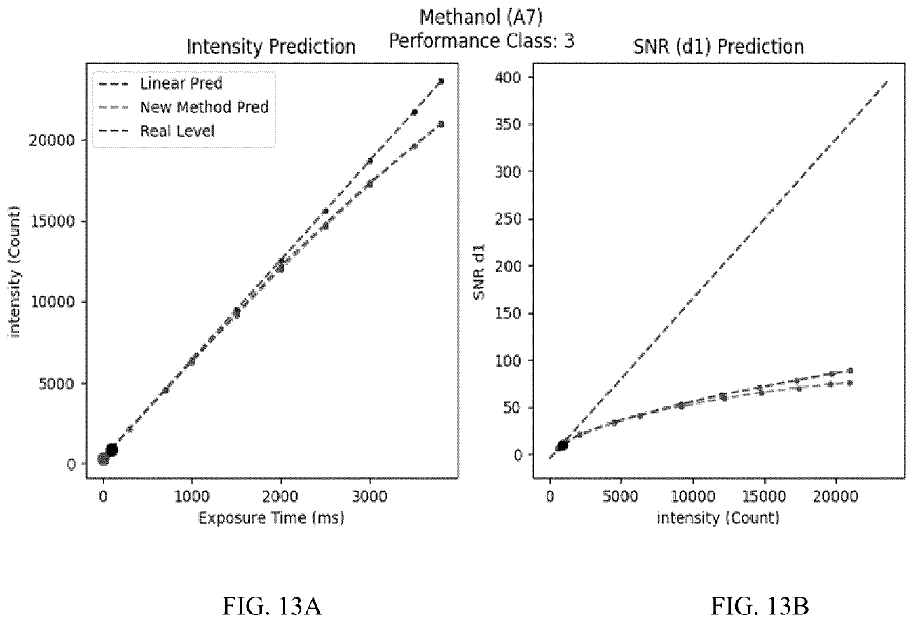

FIG. 13A illustrates an exemplary intensity to time model for an exemplary sample compound: methanol. The exemplary sample compound: methanol was determined to have performance Class 3. FIG. 13A further illustrates the linear line (e.g., calibration sample) for the scanned sample: methanol and illustrates the modified calibration sample (e.g., the intensity-to-time model) that includes a plurality of intensity levels and a plurality of exposure times that are based on an exponential deviation from the linear line.

FIG. 13B illustrates an exemplary SNR to intensity model for the exemplary sample compound: methanol. The exemplary sample compound: methanol was determined to have performance Class 3. FIG. 13B further illustrates the SNR linear line (e.g., calibration sample) for the scanned sample: methanol and illustrates the modified calibration sample (e.g., the SNR-to-intensity model) that includes a plurality of SNR values and a plurality of intensities that are based on a logarithmic deviation from the SNR linear line.

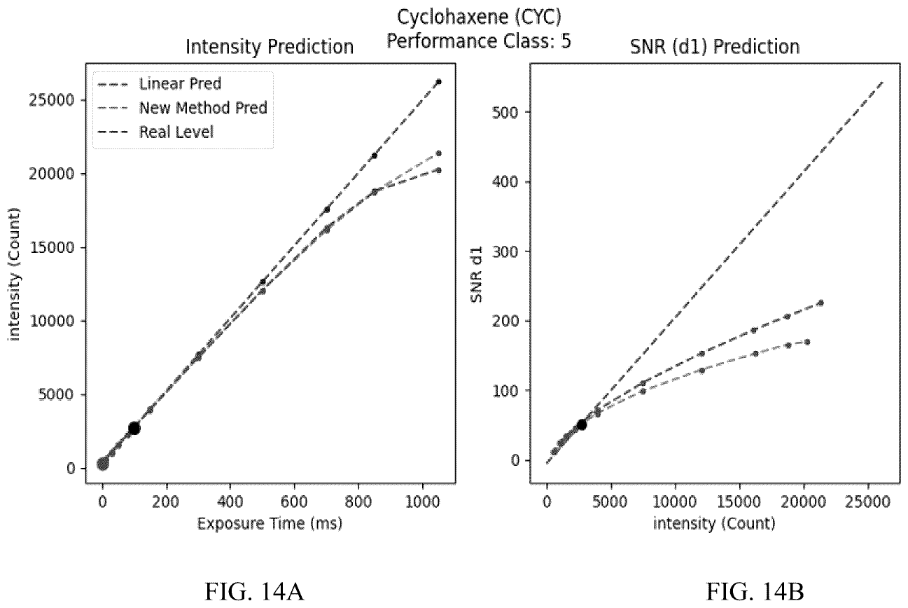

FIG. 14A illustrates an exemplary intensity to time model for an exemplary sample compound: cyclohexane. The exemplary sample compound: cyclohexane was determined to have performance Class 5. FIG. 14A further illustrates the linear line (e.g., calibration sample) for the scanned sample: cyclohexane and illustrates the modified calibration sample (e.g., the intensity-to-time model) that includes a plurality of intensity levels and a plurality of exposure times that are based on exponential deviations from the linear line. The coefficients for the exponential deviation for Class 5 are based on the calibration sample which provides A₅=0.027061, t₅=8.23×10⁻⁵, and c₅=−0.03037. In this example, the calibration sample and the test sample happen to be cyclohexane.

FIG. 14B illustrates an exemplary SNR to intensity model for the exemplary sample compound: cyclohexane. The exemplary sample compound: cyclohexane was determined to have performance Class 5. FIG. 14B further illustrates the SNR linear line (e.g., calibration sample) for the scanned sample: cyclohexane and illustrates the modified calibration sample (e.g., the SNR-to-intensity model) that includes a plurality of SNR values and a plurality of intensities that are based on a logarithmic deviation from the SNR linear line. The coefficients base on cyclohexane for the logarithmic deviation are A₅=0.335944 and c₅=−1.37313.

In some implementations, the controller 111 receives a set of program instructions to display a communication on, for example, a display, informing the user of the determined value including, at least, first maximum intensity level, first parameter exposure time, first SNR value, second maximum intensity level, second SNR value, or second parameter exposure time of the scanned sample. Alternatively, or in addition, the controller 111 may output the determined value to one or more external devices, networks, or data storage devices. The data may be provided in raw form, as part of a report, or a combination thereof. One or more alerts may also be generated based on the determined value, such as, for example, to warn a user of an error, an out-of-range sample, or the like.

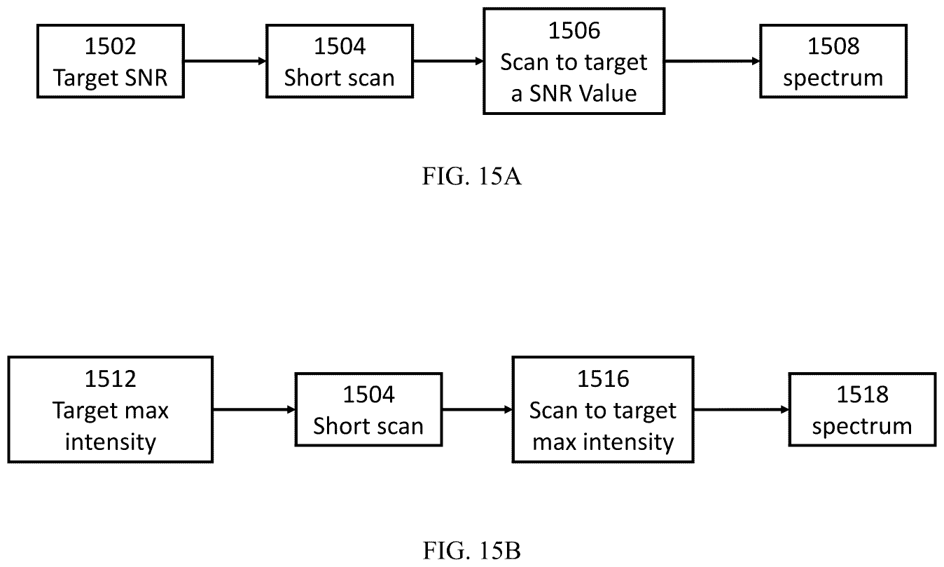

FIG. 15A is a block diagram illustrating steps an operator of a device such as a handheld Raman spectrometer may take exemplifying the benefits of the methods described herein. The controller 111 receives a set of program instructions to target a specific desired level of SNR in operation 1502. This instruction can be provided from the controller 111, such as from data stored in a memory component of the one or more data storage device(s) included in the controller 111, or as an input from the user of the device. The controller initiates a short scan 1504 (e.g., similar to the operation 602). This preliminary short scan 1504 is used to create the intensity-to-time and SNR-to-intensity models, as describe here, which are then used to determine how much scanning time is obtains the desired SNR. The controller 111 implements this determined time in a longer scan operation 1506. A spectrum with the target SNR is the provided in operation 1508. Alternatively, the intensity-to-time and SNR-to-intensity models are used to determine how much of a max-peak intensity obtains the desired SNR.

FIG. 15B is a block diagram also exemplifying the improvements of the methods described herein. The controller 111 receives a set of program instructions to target a specific desired level of max intensity in operation 1512. This instruction can be provided from the controller, such as from data stored in a memory component of the one or more data storage device(s) included in the controller 111, or from the user of the device. The controller initiates a short scan 1504. This preliminary short scan 1504 is used to create the intensity-to-time and SNR-to-intensity models, as describe here, which are then used to predict how much scanning time obtains the desired max intensity. The controller 111 implements this determined time in a longer scan operation 1516. A spectrum with the target SNR is the provided in operation 1508.

Where such methods as described here with reference to FIGS. 15A and 15B are implemented, such as on system 100 (FIG. 1) the operator may only do two operations, point a Raman laser to the sample and press an acquire button, after which a spectrum with a desired SNR or max-intensity is obtained. An additional step might include inputting the target SNR or targe max-intensity, but often these specific value for SNR will be pre-programmed and the operator can be ignorant of the values that provides the spectrum. That is, the methods and systems herein provide an improved, efficient method for obtaining data such as Raman spectra.

Accordingly, implementations described herein provide systems, methods, computing and storage devices, and computer-readable media for performing analysis of samples, such as for example, determining the SNR value of the sample. As discussed above, the implementations described herein may experience improved performance over existing prediction-based Raman spectroscopy in an efficient and cost-effective manner (e.g., without requiring complex and costly analytical instruments). For example, by scanning the sample for a short period of time (e.g., 100 ms) exemplary systems and methods predict the shortest exposure time to reach an SNR value of 100, thereby generating a more accurate prediction, increasing customer satisfaction and building customer trust with exemplary systems and methods.

The above-indicated and possibly some other related problems in the state of the art can be beneficially addressed using various examples, aspects, features, and implementations of exemplary systems and methods for prediction-based Raman spectroscopy as disclosed herein. Accordingly, incorporating prediction-based Raman spectroscopy into a system and method for predicting intensity level and SNR from a preliminary scan (e.g., 100 ms) can cause technological problems that the implementations described herein solve through particular computing systems and devices and computer-based prediction models. Thus, implementations disclosed herein provide improvements to prediction-based Raman spectroscopy.

As described above in the detailed description, reference is made to the accompanying drawings that form a part hereof wherein like numerals designate like parts throughout, and in which is shown, by way of illustration, implementations that may be practiced. It is to be understood that other implementations may be utilized, and structured or logical changes may be made, without departing from the scope of the present disclosure. Therefore, the detailed description as described above is not to be taken in a limiting sense.

Various operations may be described as multiple discrete actions or operations in turn, in a manner that is most helpful in understanding the subject matter disclosed herein. However, the order of description should be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

### CLAUSES

Implementations of the present disclosure are disclosed in the following clauses:
Clause 1. A computer-implemented method in an analytical instrument support apparatus, the method comprising:
   receiving, by one or more processors, preliminary sample data collected from a short scan of a sample;
   determining, by the one or more processors, a bright-max intensity level based on, at least, the preliminary sample data;
   determining, by the one or more processors, a performance class based on, at least, the bright-max intensity level;
   determining, by the one or more processors, an intensity-to-time model, the intensity-to-time model including a plurality of intensity levels and a plurality of exposure times based on, at least, one or more deviations from an intensity linear model, the one or more deviations associated with the determined performance class;
   determining, by the one or more processors,
      a first prediction representing a first maximum intensity level based on, at least, a first corresponding exposure time and the intensity-to-time model, or
      a second prediction representing a first parameter exposure time based on, at least, a first corresponding intensity level and the intensity-to-time model; and
   storing, on one or more computer-readable memory devices, the first maximum intensity level or the first parameter exposure time.
Clause 2. The computer-implemented method according to Clause 1, wherein determining the first prediction includes receiving, by one or more processors, first sample data collected from a first sample scan of the sample, wherein the sample is scanned for the first corresponding exposure time.
Clause 3. The computer-implemented method according to Clause 1 or Clause 2, wherein determining the second prediction includes receiving, by one or more processors, second sample data collected from a second sample scan of the sample, wherein the sample is scanned to the first corresponding intensity level.
Clause 4. The computer-implemented method according to any one of Clauses 1-3, wherein the analytical instrument support apparatus is a Raman spectrometer.
Clause 5. The computer-implemented method according to any one of Clauses 1-4, the method further comprising:
   generating, by the one or more processors, the intensity linear model, based on, at least, the bright-max intensity level associated with the preliminary sample data;
   converting, by the one or more processors, a domain of the generated intensity linear model from exposure time to intensity;
   applying, by the one or more processors, the one or more deviations to the intensity linear model; and
   converting, by the one or more processors, a domain of the intensity linear model from intensity to exposure time, to form the intensity-to-time model.
Clause 6. The computer-implemented method according to any one of Clauses 1-5, wherein the one or more deviations from the intensity linear model includes an exponential deviation.
Clause 7. The computer-implemented method according to any one of Clauses 1-6, wherein determining the intensity-to-time model includes:
   iterating the plurality of intensity levels until the first corresponding exposure time is reached on the intensity-to-time model, wherein an intensity level corresponding with the first corresponding exposure time is the first maximum intensity level, or
   iterating the plurality of exposure times until the first corresponding intensity level is reached on the intensity-to-time model, wherein an exposure time corresponding with the first corresponding intensity level is the first parameter exposure time.
Clause 8. The computer-implemented method according to any one of Clauses 1-7, the method further comprising:
   retrieving, by the one or more processors, one or more device characteristics of the analytical instrument support apparatus, wherein the device characteristics of the analytical instrument include a bias, a gain, and a sigma read; and
   determining, by the one or more processors, a base level intensity based on, at least, one of the one or more analytical instrument characteristics.
Clause 9. The computer-implemented method according to any one of Clauses 1-8, the method further comprising:
   generating, by the one or more processors, the intensity linear model based on, at least, (i) the base level intensity and (ii) the bright-max intensity level at an exposure time, wherein the exposure time is between 1 millisecond and 20 seconds.
Clause 10. The computer-implemented method according to any one of Clauses 1-9, wherein determining the performance class of the short scan of the sample includes determining the performance class is based on a selection from a plurality of performance classes,
   wherein the plurality of performance classes is based on, at least, the bright-max intensity level of the short scan of the sample at 1 millisecond to 20 seconds exposure time, and an intensity count ranging between 0 and a saturation of a detector of the analytical instrument support apparatus.
Clause 11. The computer-implemented method according to any one of Clause 1-10, the method further comprising:
   determining, by the one or more processors, an SNR-to-intensity model, the SNR-to-intensity model including a plurality of SNR values and a plurality of intensities based on, at least, one or more deviations from a SNR linear model, the one or more deviations associated with the determined performance class;
   determining, by the one or more processors,
      a third prediction representing an intensity level-based SNR value based on, at least, a second corresponding intensity level, or
      a fourth prediction representing a second maximum intensity level based on, at least, a first corresponding SNR value; and
   storing, on the one or more computer-readable memory devices, the intensity level-based SNR value or the second maximum intensity level.
Clause 12. The computer-implemented method according to Clause 11, wherein determining the third prediction includes receiving, by the one or more processors, third sample data collected from a third sample scan of the sample, wherein the sample is scanned to the second corresponding intensity level.
Clause 13. The computer-implemented method according to Clause 11, wherein determining the fourth prediction includes receiving, by the one or more processors, fourth sample data collected from a fourth sample scan of the sample, wherein the sample is scanned to the first corresponding SNR value.
Clause 14. The computer-implemented method according to any one of Clauses 1-13, the method further comprising:
   determining, by the one or more processors, a SNR-to-intensity model, the SNR-to-intensity model including a plurality of SNR values and a plurality of intensities based on, at least, one or more logarithmic deviations from a SNR linear model, the one or more logarithmic deviations associated with the determined performance class;
   determining, by the one or more processors,
      a fifth prediction representing an exposure time-based SNR value based on, at least, a second corresponding exposure time, the SNR-to-intensity model, and the intensity-to-time model, or
      a sixth prediction representing a second parameter exposure time based on, at least, a second corresponding SNR value, the SNR-to-intensity model, and the intensity-to-time model; and
   storing, on the one or more computer-readable memory devices, the exposure time-based SNR value or the second parameter exposure time.
Clause 15. The computer-implemented method according to Clause 14, wherein determining the fifth prediction includes receiving, by the one or more processors, fifth sample data collected from a fifth sample scan of the sample, wherein the sample is scanned for the second corresponding exposure time.
Clause 16. The computer-implemented method according to Clause 14, wherein determining the sixth prediction includes receiving, by the one or more processors, sixth sample data collected from a sixth sample scan of the sample, wherein the sample is scanned to the second corresponding SNR value.
Clause 17. The computer-implemented method according to Clause 14, the method further comprising:
   determining, by the one or more processors, a threshold signal-to-noise ratio (SNR) intensity value based on the preliminary sample data, wherein the preliminary sample data includes a dark Raman spectra data;
   generating, by the one or more processors, the SNR linear model, based on, at least, the threshold SNR intensity value;
   converting, by the one or more processors, a domain of the generated SNR linear model from intensity level to SNR;
   applying the one or more deviations to the SNR linear model; and
   converting, by the one or more processors, a domain of the SNR linear model from SNR to intensity level, to form the SNR-to-intensity model.
Clause 18. One or more non-transitory computer-readable media having instructions stored thereon that, when executed by one or more processing devices of an analytical instrument support apparatus, cause the analytical instrument support apparatus to perform the method of Clause 1.
Clause 19. An analytical instrument support system comprising:
   one or more processors,
   one or more non-transitory computer-readable storage media; and
   program instructions stored on any one of the one or more non-transitory computer-readable storage media for execution by at least one of the one or more processors, the program instructions comprising:
      program instructions to receive preliminary sample data collected from a short scan of a sample;
      program instructions to determine a bright-max intensity level based on, at least, the preliminary sample data;
      program instructions to determine a performance class based on, at least, the bright-max intensity level;
      program instructions to determine an intensity-to-time model, the intensity-to-time model including a plurality of intensity levels and a plurality of exposure times based on, at least, one or more deviations from an intensity linear model, the one or more deviations associated with the determined performance class;
      program instructions to determine,
         a first prediction representing a first maximum intensity level based on, at least, a first corresponding exposure time and the intensity-to-time model, or
         a second prediction representing a first parameter exposure time based on, at least, a first corresponding intensity level and the intensity-to-time model; and
   program instructions to store, on one or more computer-readable memory devices, the first maximum intensity level or the first parameter exposure time.
Clause 20. The analytical instrument support system according to Clause 19, wherein the program instructions are executed on a common computing device including at least one of the one or more processors.
Clause 21. The analytical instrument support system according to either of Clauses 19 or 20, wherein the program instructions are executed on a computing device, including at least one of the one or more processors, remote from an analytical instrument.
Clause 22. The analytical instrument support system according to any one of Clauses 19-21, wherein the program instructions are executed on a user computing device including at least one of the one or more processors.
Clause 23. The analytical instrument support system according to Clause 20, wherein the program instructions are executed on the analytical instrument including at least one of the one or more processors.
Clause 24. An analytical instrument comprising:
   a light source configured to direct light onto a surface of a sample;
   a spectrograph to acquire a Raman spectrum from the surface of the sample in response to the light source directing light onto the surface of the sample;
   one or more processors;
   one or more non-transitory computer-readable storage media; and
   program instructions stored on at least one of the one or more non-transitory computer-readable storage media for execution by at least one of the one or more processors, wherein upon execution of the program instructions by at least one of the one or more processors, cause the analytical instrument to implement a set of acts comprising:
      analyzing Raman spectrum data from the acquired Raman spectrum associated with the surface of the sample,
      determining a bright-max intensity level based on, at least, the acquired Raman spectrum,
      determining a performance class based on the bright-max intensity level associated with the acquired Raman spectrum,
      determining an intensity-to-time model, the intensity-to-time model including a plurality of intensity levels and a plurality of exposure times based on, at least, one or more deviations from an intensity linear model, the one or more deviations associated with the determined performance class;
      determining a first maximum intensity level based on, at least, a first corresponding exposure time and the intensity-to-time model, or, a first parameter exposure time based on, at least, a first corresponding intensity level and the intensity-to-time model, and
      storing on at least one of the one or more non-transitory computer-readable storage media the first maximum intensity level or the first parameter exposure time.
Clause 25. The analytical instrument according to Clause 24, wherein the set of acts further comprises:
   determining an SNR-to-intensity model, the SNR-to-intensity model including a plurality of SNR values and a plurality of intensities based on, at least, one or more deviations from a SNR linear model, the one or more deviations associated with the determined performance class;
   determining,
      an intensity level-based SNR value based on, at least, a second corresponding intensity level, or
      a second maximum intensity level based on, at least, a first corresponding SNR value; and
   storing, on one or more computer-readable memory devices, the intensity level-based SNR value or the second maximum intensity level.
Clause 26. The analytical instrument according to Clause 25, wherein the set of acts further comprises:
   determining an SNR-to-intensity model, the SNR-to-intensity model including a plurality of SNR values and a plurality of intensities based on, at least, one or more logarithmic deviations from a SNR linear model, the one or more logarithmic deviations associated with the determined performance class;
   determining,
      an exposure time-based SNR value based on, at least, a second corresponding exposure time, the SNR-to-intensity model, and the intensity-to-time model or
      a second parameter exposure time based on, at least, a second corresponding SNR value, the SNR-to-intensity model, and the intensity-to-time model; and
   storing, on the one or more computer-readable memory devices, the exposure time-based SNR value or the second parameter exposure time.
Clause 27. The analytical instrument according to Clause 26, wherein the set of acts further comprises:
   determining a threshold signal-to-noise ratio (SNR) intensity value based on the preliminary sample data, wherein the preliminary sample data includes a dark Raman spectra data;
   generating the SNR liner model based on, at least, the SNR linear model, based on, at least, the threshold SNR intensity value;
   converting a domain of the generated SNR linear model from intensity level to SNR;
   applying the one or more deviations to the SNR linear model; and
   converting a domain of the provided deviation from the SNR linear model from SNR to intensity level, to form the SNR-to-intensity model.

What is claimed is:

1. A computer-implemented method in an analytical instrument support apparatus, the method comprising:
receiving, by one or more processors, preliminary sample data collected from a short scan of a sample;
determining, by the one or more processors, a bright-max intensity level based on, at least, the preliminary sample data;
determining, by the one or more processors, a performance class based on, at least, the bright-max intensity level;
determining, by the one or more processors, an intensity-to-time model, the intensity-to-time model including a plurality of intensity levels and a plurality of exposure times based on, at least, one or more deviations from an intensity linear model, the one or more deviations associated with the determined performance class;
determining, by the one or more processors,
a first prediction representing a first maximum intensity level based on, at least, a first corresponding exposure time and the intensity-to-time model, or
a second prediction representing a first parameter exposure time based on, at least, a first corresponding intensity level and the intensity-to-time model; and
storing, on one or more computer-readable memory devices, the first maximum intensity level or the first parameter exposure time.

2. The computer-implemented method of claim 1, wherein determining the first prediction includes receiving, by the one or more processors, first sample data collected from a first sample scan of the sample, wherein the sample is scanned for the first corresponding exposure time.

3. The computer-implemented method of claim 1, wherein determining the second prediction includes receiving, by the one or more processors, second sample data collected from a second sample scan of the sample, wherein the sample is scanned to the first corresponding intensity level.

4. The computer-implemented method of claim 1, wherein the analytical instrument support apparatus is a Raman spectrometer.

5. The computer-implemented method of claim 1, the method further comprising:
generating, by the one or more processors, the intensity linear model, based on, at least, the bright-max intensity level associated with the preliminary sample data;
converting, by the one or more processors, a domain of the generated intensity linear model from exposure time to intensity;
applying, by the one or more processors, the one or more deviations to the intensity linear model; and
converting, by the one or more processors, a domain of the intensity linear model from intensity to exposure time, to form the intensity-to-time model.

6. The computer-implemented method of claim 5, wherein the one or more deviations from the intensity linear model includes an exponential deviation.

7. The computer-implemented method of claim 1, wherein determining the intensity-to-time model includes:
iterating the plurality of intensity levels until the first corresponding exposure time is reached on the intensity-to-time model, wherein an intensity level corresponding with the first corresponding exposure time is the first maximum intensity level, or
iterating the plurality of exposure times until the first corresponding intensity level is reached on the intensity-to-time model, wherein an exposure time corresponding with the first corresponding intensity level is the first parameter exposure time.

8. The computer-implemented method of claim 5, the method further comprising:
retrieving, by the one or more processors, one or more device characteristics of the analytical instrument support apparatus, wherein the device characteristics of the analytical instrument include a bias, a gain, and a sigma read; and
determining, by the one or more processors, a base level intensity based on, at least, one of the one or more analytical instrument characteristics.

9. The computer-implemented method of claim 8, the method further comprising generating, by the one or more processors, the intensity linear model based on, at least, (i) the base level intensity and (ii) the bright-max intensity level at an exposure time, wherein the exposure time is between 1 millisecond and 20 seconds.

10. The computer-implemented method of claim 1, wherein the determining of the performance class of the short scan of the sample is based on a selection from a plurality of performance classes, and
wherein the plurality of performance classes is based on, at least, the bright-max intensity level of the short scan of the sample at 1 millisecond to 20 seconds exposure time, and an intensity count ranging between 0 and a saturation value of a detector of the analytical instrument support apparatus.

11. The computer-implemented method of claim 1, the method further comprising:
determining, by the one or more processors, an SNR-to-intensity model, the SNR-to-intensity model including a plurality of SNR values and a plurality of intensities based on, at least, one or more deviations from a SNR linear model, the one or more deviations associated with the determined performance class;
determining, by the one or more processors,
a third prediction representing an intensity level-based SNR value based on, at least, a second corresponding intensity level, or
a fourth prediction representing a second maximum intensity level based on, at least, a first corresponding SNR value; and
storing, on the one or more computer-readable memory devices, the intensity level-based SNR value or the second maximum intensity level.

12. The computer-implemented method of claim 11, wherein determining the third prediction includes receiving, by the one or more processors, third sample data collected from a third sample scan of the sample, wherein the sample is scanned to the second corresponding intensity level.

13. The computer-implemented method of claim 11, wherein determining the fourth prediction includes receiving, by the one or more processors, fourth sample data collected from a fourth sample scan of the sample, wherein the sample is scanned to the first corresponding SNR value.

14. The computer-implemented method according to claim 1, the method further comprising:
determining, by the one or more processors, a SNR-to-intensity model, the SNR-to-intensity model including a plurality of SNR values and a plurality of intensities based on, at least, one or more logarithmic deviations from a SNR linear model, the one or more logarithmic deviations associated with the determined performance class;
determining, by the one or more processors,
a fifth prediction representing an exposure time-based SNR value based on, at least, a second corresponding exposure time, the SNR-to-intensity model, and the intensity-to-time model, or
a sixth prediction representing a second parameter exposure time based on, at least, a second corresponding SNR value, the SNR-to-intensity model, and the intensity-to-time model; and
storing, on the one or more computer-readable memory devices, the exposure time-based SNR value or the second parameter exposure time.

15. The computer-implemented method according to claim 14, wherein determining the fifth prediction includes receiving, by the one or more processors, fifth sample data collected from a fifth sample scan of the sample, wherein the sample is scanned for the second corresponding exposure time.

16. The computer-implemented method according to claim 14, wherein determining the sixth prediction includes receiving, by the one or more processors, sixth sample data collected from a sixth sample scan of the sample, wherein the sample is scanned at the second corresponding SNR value.

17. The computer-implemented method according to claim 14, the method further comprising:
determining, by the one or more processors, a threshold signal-to-noise ratio (SNR) intensity value based on the preliminary sample data, wherein the preliminary sample data includes a dark Raman spectra data;
generating, by the one or more processors, the SNR linear model based on, at least, the threshold SNR intensity value;
converting, by the one or more processors, a domain of the generated SNR linear model from intensity level to SNR;
applying the one or more deviations to the SNR linear model; and
converting, by the one or more processors, a domain of the SNR linear model from SNR to intensity level, to form the SNR-to-intensity model.

18. An analytical instrument support system comprising:
one or more processors,
one or more non-transitory computer-readable storage media; and
program instructions stored on at least one of the one or more non-transitory computer-readable storage media for execution by at least one of the one or more processors, the program instructions comprising:
program instructions to receive, preliminary sample data collected from a short scan of a sample;
program instructions to determine a bright-max intensity level based on, at least, the preliminary sample data;
program instructions to determine a performance class based on, at least, the bright-max intensity level;
program instructions to determine an intensity-to-time model, the intensity-to-time model including a plurality of intensity levels and a plurality of exposure times based on, at least, one or more deviations from an intensity linear model, the one or more deviations associated with the determined performance class;
program instructions to determine,
a first prediction representing a first maximum intensity level based on, at least, a first corresponding exposure time and the intensity-to-time model, or
a second prediction representing a first parameter exposure time based on, at least, a first corresponding intensity level and the intensity-to-time model; and
program instructions to store, on one or more computer-readable memory devices, the first maximum intensity level or the first parameter exposure time.

19. The analytical instrument support system of claim 18, wherein the program instructions are executed on a common computing device including at least one of the one or more processors.

20. An analytical instrument comprising:
a light source configured to direct light onto a surface of a sample;
a spectrograph to acquire a Raman spectrum from the surface of the sample in response to the light source directing light onto the surface of the sample;
one or more processors;
one or more non-transitory computer-readable storage media; and
program instructions stored on at least one of the one or more non-transitory computer-readable storage media for execution by at least one of the one or more processors, wherein upon execution of the program instructions by at least one of the one or more processors, cause the analytical instrument to implement a set of acts comprising:
analyzing Raman spectrum data from the acquired Raman spectrum associated with the surface of the sample,
determining a bright-max intensity level based on, at least, the acquired Raman spectrum,
determining a performance class based on the bright-max intensity level associated with the acquired Raman spectrum,
determining an intensity-to-time model, the intensity-to-time model including a plurality of intensity levels and a plurality of exposure times based on, at least, one or more deviations from an intensity linear model, the one or more deviations associated with the determined performance class;
determining a first maximum intensity level based on, at least, a first corresponding exposure time and the intensity-to-time model, or, a first parameter exposure time based on, at least, a first corresponding intensity level and the intensity-to-time model, and
storing on at least one of the one or more non-transitory computer-readable storage media the first maximum intensity level or the first parameter exposure time.
